(19) United States
(12) Patent Application Publication
(10) Pub. No.: US 2026/0101221 A1
(43) Pub. Date: Apr. 9, 2026

(54) METHOD AND APPARATUS FOR AIML ASSISTED MOBILITY IN A WIRELESS COMMUNICATION SYSTEM

(71) Applicant: ASUS Technology Licensing Inc., Taipei City (TW)

(72) Inventors: Cheng-Hsiu Chen, Taipei City (TW); Meng-Hui Ou, Taipei City (TW)

(21) Appl. No.: 19/346,181

(22) Filed: Sep. 30, 2025

Related U.S. Application Data
(60) Provisional application No. 63/703,826, filed on Oct. 4, 2024.
(60) Provisional application No. 63/864,934, filed on Aug. 15, 2025.

(51) Int. Cl. H04W 24/10

(52) U.S. Cl. CPC H04W 24/10

(57) ABSTRACT

Methods, systems, and apparatuses are provided for Artificial Intelligence/Machine Learning (AI/ML) assisted mobility in a wireless communication system, wherein a method of a User Equipment (UE) comprises triggering a measurement report, and including multiple measurement results, at multiple time instances for a cell, in a measurement report, wherein the multiple time instances comprise one or more of: (i) time instances configured by a Network (NW); and (ii) time instances within a time window configured by the NW.

### CROSS-REFERENCE TO RELATED APPLICATIONS

The present application claims priority to and the benefit of U.S. Provisional Patent Application Ser. No. 63/703,826, filed Oct. 4, 2024, and U.S. Provisional Patent Application Ser. No. 63/864,934, filed Aug. 15, 2025; with each of the referenced and listed applications and disclosures hereby fully incorporated herein by reference.

### FIELD

This disclosure generally relates to wireless communication networks and, more particularly, to a method and apparatus for Artificial Intelligence/Machine Learning (AI/ML) assisted mobility in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for Artificial Intelligence and Machine Learning (AI/ML) assisted mobility in a wireless communication system such that a Network (NW) may receive useful measurement results to assist in handover decisions.

In various embodiments, a method for a User Equipment (UE) in a wireless communication system comprises triggering a measurement report, and including multiple measurement results, at multiple time instances for a cell, in a measurement report, wherein the multiple time instances comprise one or more of: (i) time instances configured by a NW; and (ii) time instances within a time window configured by the NW.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 5.5.5.1-1: Measurement reporting, from 3GPP TS 38.331 V18.1.0 (2024-03) 3GPP.

FIG. 6 is an example diagram showing how an AI model for RRM prediction works, in accordance with embodiments of the present invention.

FIG. 7 is an example diagram showing a UE (is configured to) include multiple measurement results at multiple time instances (e.g., for a cell) in a measurement report, wherein the UE may be restricted (or limited) to include measurement results within a time window, in accordance with embodiments of the present invention.

FIG. 8 is a flow diagram of a method of a UE in a wireless communication system comprising transmitting a message including measurement result(s) to a network, not including some measurement results and some cells, and differentiating the message from the message triggered based on actual measurements, in accordance with embodiments of the present invention.

FIG. 9 is a flow diagram of a method of a UE in a wireless communication system comprising transmitting a message including measurement results to a network, predicting some measurement results of some cells, and differentiating the message from the message triggered based on actual measurements, in accordance with embodiments of the present invention.

FIG. 10 is a flow diagram of a method of a UE in a wireless communication system comprising transmitting a message including measurement results to a network, including some actual measurements, and differentiating the message from the message triggered based on actual measurements, in accordance with embodiments of the present invention.

FIG. 11 is a flow diagram of a method of a UE in a wireless communication system comprising transmitting a message including measurement results to a network, including some measurements of multiple time instances, and differentiating the message from the message triggered based on actual measurements, in accordance with embodiments of the present invention.

FIG. 12 is a flow diagram of a method of a UE in a wireless communication system comprising receiving a first configuration for reporting measurements, and including measurement results at multiple time instances for a cell in a measurement report, and the multiple time instances are within a time window including a reference time, in accordance with embodiments of the present invention.

FIG. 13 is a flow diagram of a method of a UE in a wireless communication system comprising triggering a measurement report, and including multiple measurement results, at multiple time instances for a cell, in a measurement report, wherein the multiple time instances comprise one or more of: (i) time instances configured by a NW; and (ii) time instances within a time window configured by the NW, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-240082, “Revised SID on AIML for mobility in NR”; [2]3GPP TR 38.843 V18.0.0 (2023-12) 3GPP; TSG RAN; Study on Artificial Intelligence (AI)/Machine Learning (ML) for NR air interface (Release 18); and [3] 3GPP TS 38.331 V18.1.0 (2024-03) 3GPP; TSG RAN; NR; Radio Resource Control (RRC) protocol specification (Release 18). The standards and documents listed above are hereby expressly and fully incorporated herein by reference in their entirety.

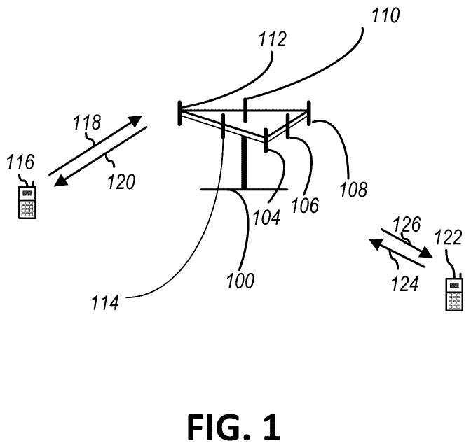

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

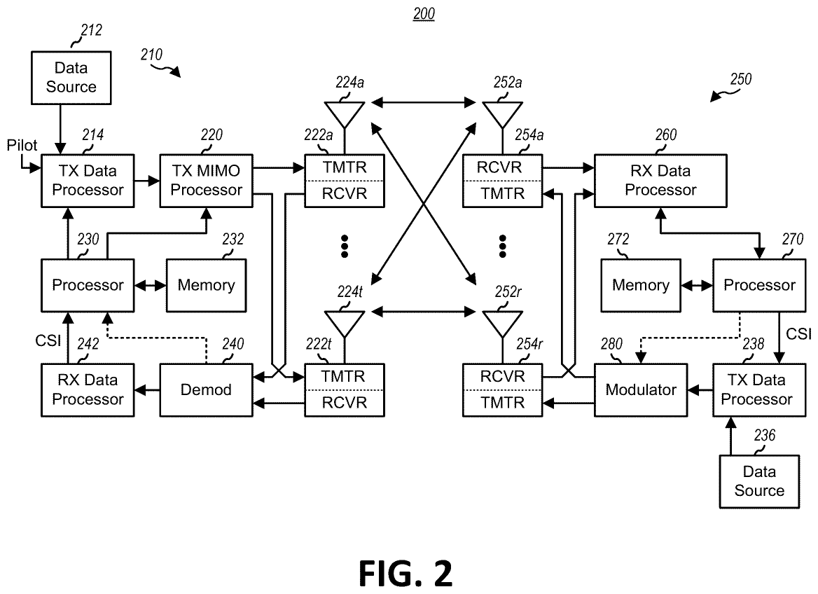

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

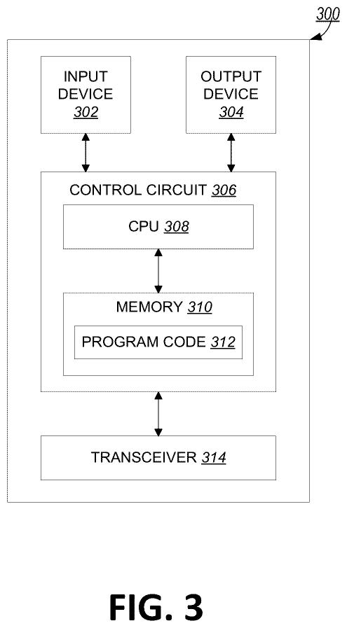

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

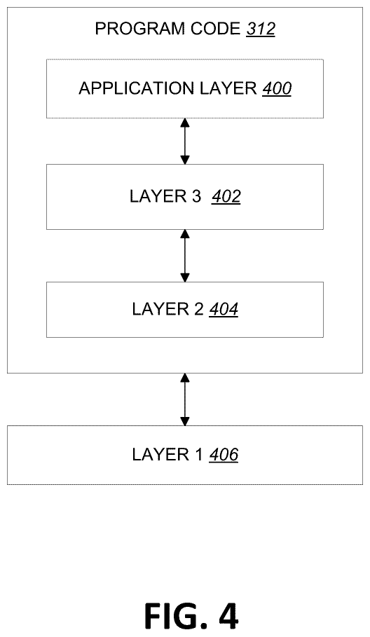

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In SID RP-240082 ([1] RP-240082, “Revised SID on AIML for mobility in NR”), the objectives of AI/ML Mobility are specified:

### ******************************** Start of Quotation [1] *******************************

### 3 Justification

With existing L3 handover mechanism, handover is triggered and executed based on reported historical measurement result aid/or measurement event(s) i.e., it is kind of reactive scheme by its nature. It may work well among macro cells when UE's mobility is low for existing services. But it could be problematic when either UE's mobility is high or among micro cells of high density or both for existing services or future services e.g. XR, where such reactive scheme may result in more unintended event e.g., handover failure, radio link failure, Ping-Pong phenomenon, throughput loss or too early/late handover etc. To improve handover robustness conditional handover is introduced in Rel-16. And to reduce interruption time of frequent handover among small cells LTM HO is introduced in Rel-18. However, these two mechanisms are not sufficient because they are still reactive scheme by design. On the other hand, mechanism based on AI/ML algorithm has the potential to enable proactive scheme.

In Rel-18 SID called FS_NR_AIML_air was studied extensively on physical layer centric use cases including spatial and temporal beam prediction. Temporal prediction within serving cell is mainly to predict the best or top-K beam(s) or beam pair(s) in time domain in order to improve UE throughput. While predict the best or top-K beam(s) or beam pair(s) among a set of beams by measuring a smaller set of beams could help reduce RS signalling overhead, measurement efforts and UE power consumption etc. By extended L1 beam measurement from serving cell to neighbouring cell, majority of the RAN1 work can be reused. Since L3 measurement is based on filtering of L1 measurement, the study of AI/ML for air can be leveraged for mobility purpose e.g., temporal prediction can also be used to predict beam(s)/cell(s) becoming worse so that unintended event like radio link failure or short-stay handover can be avoided.

Mobility enhancement was also studied in RAN3 in Rel-17 in SID called FS_NR_ENDC_data_collect and is now specified in Rel-18 WID NR_AIML_NGRAN-Core. In these RAN3 items the study and normative work on mobility enhancement is based on information available in network side e.g. handover and stay of time in history among cells to predict UE's trajectory in single hop and hence potential candidates. In Rel-19 RAN3 will further work on UE's trajectory for multiple hops. The predicted UE's trajectory could be helpful for study on AI/ML mobility over air interface to some extent.

Based on progress made in RAN1 and RAN3 so far and assumption on UE's trajectory it is feasible to predict RRM measurement and/or event and hence candidate target cell in UE side. In network side new assistant information, if necessary, and statistics information based on measurement report from UE and/or neighbouring nodes can be also used for smart prediction. If some prediction information could be known by network, handover and/or RRM performance can be improved by proactive measures to either make a better decision or avoid unintended event.

### 4 Objective

### 4.1 Objective of SI or Core Part WI or Testing Part WI

The study will focus on mobility enhancement in RRC_CONNECTED mode over air interface by following existing mobility framework, i.e., handover decision is always made in network side. Mobility use cases focus on standalone NR PCell change. UE-side and network-side AI/ML model can be both considered, respectively.

Study and evaluate potential benefits and gains of AI/ML aided mobility for network triggered L3-based handover, considering the following aspects:
AI/ML based RRM measurement and event prediction,
   Cell-level measurement prediction including intra and inter-frequency (UE sided and NW sided model) [RAN2]
      Inter-cell Beam-level measurement prediction for L3 Mobility (UE sided and NW sided model) [RAN2]
   HO failure/RLF prediction (UE sided model) [RAN2]
   Measurement events prediction (UE sided model) [RAN2]
Study the need/benefits of any other UE assistance information for the network side model [RAN2]
The evaluation of the AI/ML aided mobility benefits should consider HO performance KPIs (e.g., Ping-pong HO, HOF/RLF, Time of stay, Handover interruption, prediction accuracy, and measurement reduction) etc.) and complexity tradeoffs [RAN2]
   NOTE: Simulation assumption and methodology can leverage TR 38.901, 38.843 and 36.839. And leave the detail discussion to RAN2
Potential AI mobility specific enhancement should be based on the Rel19 AI/ML-air interface WID general framework (e.g. LCM, performance monitoring etc) [RAN2]
   NOTE: This would only be treated after sufficient progress is made in the Rel-19 AI/ML air interface WID
Potential specification impacts of AI/ML aided mobility [RAN2]
Evaluate testability, interoperability, and impacts on RRM requirements and performance [RAN4]

### ********************************* End of Quotation [1] ********************************

In TR 38.843 ([2]3GPP TR 38.843 V18.0.0 (2023-12) 3GPP; TSG RAN), a general framework and operations for LCM is studied:

### ******************************** Start of Quotation [2] *******************************

4 General AI/ML framework

The purpose of this clause is to identify common notation and terminology for AI/ML related functions, procedures and interfaces.

### 4.1 Description of AI/ML Stages

In this clause, the defining stages of AI/ML related algorithms and associated complexity are characterized, namely:
Model generation, e.g., model training (including input/output, pre-/post-process, online/offline as applicable), model validation, model testing, as applicable
Inference operation, e.g., input/output, pre-/post-process, as applicable

In addition, the treatment of dataset(s) for training, validation, testing, and inference is documented.

### 4.2 Life Cycle Management

In this clause, the life cycle management (LCM) of AI/ML model (e.g., model training, model deployment, model inference, model monitoring, model updating) and AI/ML functionality are characterized.

The following aspects, including the definition of components (if needed) and necessity, are studied in LCM:
Data collection
   Note: This also includes associated assistance information, if applicable.
Model training
Functionality/model identification
Model delivery/transfer
Model inference operation
Functionality/model selection, activation, deactivation, switching, and fallback operation.
   Including: Decision by the network (either network initiated or UE-initiated and requested to the network), decision by the UE (event-triggered as configured by the network, UE's decision reported to the network, or UE-autonomous either with UE's decision reported to the network or without it)
Functionality/model monitoring
Model update
   UE capability

### 4.2.1 LCM Flavours

The LCM procedure is studied for the case that an AI/ML model has a model ID with associated information and/or for the case that a given functionality is provided by some AI/ML operations. Note: Applicability of functionality-based LCM and model-ID-based LCM is a separate discussion.

From RAN1 perspective, an AI/ML model identified by a model ID may be logical, and how it maps to physical AI/ML model(s) may be up to implementation. When distinction is necessary for discussion purposes, companies may use the term a logical AI/ML model to refer to a model that is identified and assigned a model ID, and physical AI/ML model(s) to refer to an actual implementation of such a model.

For UE-side models and UE-part of two-sided models:
For AI/ML functionality identification
   Legacy 3GPP framework of feature is taken as a starting point.
   UE indicates supported functionalities/functionality for a given sub-use-case.
      UE capability reporting is taken as starting point.
   For AI/ML model identification
      Models are identified by model ID at the Network. UE indicates supported AI/ML models.

In functionality-based LCM, network indicates activation/deactivation/fallback/switching of AI/ML functionality via 3GPP signalling (e.g., RRC, MAC-CE, DCI). Models may not be identified at the Network, and UE may perform model-level LCM. Whether and how much awareness/interaction NW should have about model-level LCM requires further study. For functionality identification, there may be either one or more than one Functionalities defined within an AI/ML-enabled feature, whereby AI/ML-enabled Feature refers to a Feature where AI/ML may be used. Note: UE may have one AI/ML model for the functionality, or UE may have multiple AI/ML models for the functionality.

For AI/ML functionality identification and functionality-based LCM of UE-side models and/or UE-part of two-sided models, functionality refers to an AI/ML-enabled Feature/FG enabled by configuration(s), where configuration(s) is(are) supported based on conditions indicated by UE capability. Correspondingly, functionality-based LCM operates based on, at least, one configuration of AI/ML-enabled Feature/FG or specific configurations of an AI/ML-enabled Feature/FG.

After functionality identification, necessity, mechanisms, for UE to report updates on applicable functionality(es) among functionality(es) are studied, where the applicable functionalities may be a subset of all functionalities. Applicable functionalities can be reported by the UE.

In model-ID-based LCM, models are identified at the Network, and Network/UE may activate/deactivate/select/switch individual AI/ML models via model ID.

For AI/ML model identification and model-ID-based LCM of UE-side models and/or UE-part of two-sided models, model-ID-based LCM operates based on identified models, where a model may be associated with specific configurations/conditions associated with UE capability of an AI/ML-enabled Feature/FG and additional conditions (e.g., scenarios, sites, and datasets) as determined/identified between UE-side and NW-side.

After model identification, necessity, mechanisms, for UE to report updates on applicable UE part/UE-side model(s), are studied, where the applicable models may be a subset of all identified models. Applicable models can be reported by the UE.

How to handle the impact of UE's internal conditions such as memory, battery, and other hardware limitations on functionality/model operations and AI/ML-enabled Feature is to be studied. Note: it does not preclude any existing solutions.

For functionality/model-ID based LCM, once functionalities/models are identified, the same or similar procedures may be used for their activation, deactivation, switching, fallback, and monitoring.

Model ID, if needed, can be used in a Functionality (defined in functionality-based LCM) for LCM operations.

### ********************************* End of Quotation [2] *******************************

In TS 38.331 ([3] 3GPP TS 38.331 V18.1.0 (2024-03) 3GPP), the procedure for measurement is specified:

### ******************************** Start of Quotation [3] *******************************

### 5.5 Measurements

### 5.5.1 Introduction

The network may configure an RRC_CONNECTED UE to perform measurements. The network may configure the UE to report them in accordance with the measurement configuration or perform conditional reconfiguration evaluation in accordance with the conditional reconfiguration. The measurement configuration is provided by means of dedicated signalling i.e. using the RRCReconfiguration or RRCResume.

The network may configure the UE to perform the following types of measurements:
NR measurements;
Inter-RAT measurements of E-UTRA frequencies;
Inter-RAT measurements of UTRA-FDD frequencies;
NR sidelink measurements of L2 U2N Relay UEs.

The network may configure the UE to report the following measurement information based on SS/PBCH block(s):
Measurement results per SS/PBCH block;
Measurement results per cell based on SS/PBCH block(s);
SS/PBCH block(s) indexes.

The network may configure the UE to report the following measurement information based on CSI-RS resources:
Measurement results per CSI-RS resource;
Measurement results per cell based on CSI-RS resource(s);
CSI-RS resource measurement identifiers.

The measurement configuration includes the following parameters:
1. Measurement objects: A list of objects on which the UE shall perform the measurements.
   For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.
   The measObjectId of the MO which corresponds to each serving cell is indicated by servingCellMO within the serving cell configuration.
   For inter-RAT E-UTRA measurements a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting.
   For inter-RAT UTRA-FDD measurements a measurement object is a set of cells on a single UTRA-FDD carrier frequency.
2. Reporting configurations: A list of reporting configurations where there can be one or multiple reporting configurations per measurement object. Each measurement reporting configuration consists of the following:
   Reporting criterion: The criterion that triggers the UE to send a measurement report. This can either be periodical or a single event description.
   RS type: The RS that the UE uses for beam and cell measurement results (SS/PBCH block or CSI-RS).
   Reporting format: The quantities per cell and per beam that the UE includes in the measurement report (e.g. RSRP) and other associated information such as the maximum number of cells and the maximum number beams per cell to report.
In case of conditional reconfiguration, each configuration consists of the following:
   Execution criteria: The criteria the UE uses for conditional reconfiguration execution.
   RS type: The RS that the UE uses for obtaining beam and cell measurement results (SS/PBCH block-based or CSI-RS-based), used for evaluating conditional reconfiguration execution condition.
3. Measurement identities: For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.
4. Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.
5. Measurmment gaps: Periods that the UE may use to perform measurements.
6. Effective measumment window: Periods that the UE may use to perform inter RAT measurements.

A UE in RRC_CONNECTED maintains a measurement object list, a reporting configuration list, and a measurement identities list according to signalling and procedures in this specification. The measurement object list possibly includes NR measurement object(s), CLI measurement object(s), inter-RAT objects, and L2 U2N Relay objects. Similarly, the reporting configuration list includes NR, inter-RAT, and L2 U2N Relay reporting configurations. Any measurement object can be linked to any reporting configuration of the same RAT type. Some reporting configurations may not be linked to a measurement object. Likewise, some measurement objects may not be linked to a reporting configuration.

The measurement procedures distinguish the following types of cells:
1. The NR serving cell(s)—these are the SpCell and one or more SCells.
2. Listed cells—these are cells listed within the measurement object(s).
3. Detected cells—these are cells that are not listed within the measurement object(s) but are detected by the UE on the SSB frequency(ies) and subcarrier spacing(s) indicated by the measurement object(s).

For NR measurement object(s), the UE measures and reports on the serving cell(s)/serving Relay UE (for L2 U2N Remote UE), listed cells and/or detected cells. For inter-RAT measurements object(s) of E-UTRA, the UE measures and reports on listed cells and detected cells and, for RSSI and channel occupancy measurements, the UE measures and reports on the configured resources on the indicated frequency. For inter-RAT measurements object(s) of UTRA-FDD, the UE measures and reports on listed cells. For CLI measurement object(s), the UE measures and reports on configured measurement resources (i.e. SRS resources and/or CLI-RSSI resources). For L2 U2N Relay object(s), the UE measures and reports on the serving NR cell(s), as well as the discovered L2 U2N Relay UEs.

Whenever the procedural specification, other than contained in clause 5.5.2, refers to a field it concerns a field included in the VarMeasConfig unless explicitly stated otherwise i.e. only the measurement configuration procedure covers the direct UE action related to the received measConfig.

In NR-DC, the UE may receive two independent measConfig:
a measConfig, associated with MCG, that is included in the RRCReconfiguration message received via SRB1; and
a measConfig, associated with SCG, that is included in the RRCReconfiguration message received via SRB3, or, alternatively, included within a RRCReconfiguration message enbedded in a RRCReconfiguration message received via SRB1.

In this case, the UE maintains two independent VarMeasConfig and VarMeasReportList, one associated with each measConfig, and independently performs all the procedures in clause 5.5 for each measConfig and the associated VarMeasConfig and VarMeasReportList, unless explicitly stated otherwise.

. . .
5.5.3 Performing measurements

### 5.5.3.1 General

An RRC_CONNECTED UE shall derive cell measurement results by measuring one or multiple beams associated per cell as configured by the network, as described in 5.5.3.3. For all cell measurement results, except for RSSI, and CLI measurement results in RRC_CONNECTED, the UE applies the layer 3 filtering as specified in 5.5.3.2, before using the measured results for evaluation of reporting criteria, measurement reporting or the criteria to trigger conditional reconfiguration execution. For cell measurements, the network can configure RSRP, RSRQ, SINR, RSCP or EcN0 as trigger quantity. For CLI measurements, the network can configure SRS-RSRP or CLI-RSSI as trigger quantity. For cell and beam measurements, reporting quantities can be any combination of quantities (i.e. only RSRP; only RSRQ; only SINR; RSRP and RSRQ; RSRP and SINR; RSRQ and SINR; RSRP, RSRQ and SINR; only RSCP; only EcN0; RSCP and EcN0), irrespective of the trigger quantity, and for CLI measurements, reporting quantities can be either SRS-RSRP or CLI-RSSI. For conditional reconfiguration execution, the network can configure up to 2 quantities, both using same RS type. The UE does not apply the layer 3 filtering as specified in 5.5.3.2 to derive the CBR measurements. The UE does not apply the layer 3 filtering as specified in 5.5.3.2 to derive the Rx-Tx time difference measurements. The UE does not apply the layer 3 filtering as specified in 5.5.3.2 to derive the altitude measurements.

The network may also configure the UE to report measurement information per beam (which can either be measurement results per beam with respective beam identifier(s) or only beam identifier(s)), derived as described in 5.5.3.3a. If beam measurement information is configured to be included in measurement reports, the UE applies the layer 3 beam filtering as specified in 5.5.3.2. On the other hand, the exact L1 filtering of beam measurements used to derive cell measurement results is implementation dependent.

The UE shall:
1> whenever the UE has a measConfig, perform RSRP and RSRQ measurements for each serving cell for which servingCellMO is configured as follows:
   2> if the reportConfig associated with at least one measId included in the measIdList within VarMeasConfig contains an rsType set to ssb and ssb-ConfigMobility is configured in the measObject indicated by the servingCellMO:
      3> if the reportConfig associated with at least one measId included in the measIdList within VarMeasConfig contains a reportQuantityRS-Indexes and maxNrofRS-IndexesToReport and contains an rsType set to ssb:
         4> derive layer 3 filtered RSRP and RSRQ per beam for the serving cell based on SS/PBCH block, as described in 5.5.3.3a;
      3> derive serving cell measurement results based on SS/PBCH block, as described in 5.5.3.3;
   2> if the reportConfig associated with at least one measId included in the measIdList within VarMeasConfig contains an rsType set to csi-rs and CSI-RS-ResourceConfigMobility is configured in the measObject indicated by the servingCellMO:
      3> if the reportConfig associated with at least one measId included in the measIdList within VarMeasConfig contains a reportQuantityRS-Indexes and maxNrofRS-IndexesToReport and contains an rsType set to csi-rs:
         4> derive layer 3 filtered RSRP and RSRQ per beam for the serving cell based on CSI-RS, as described in 5.5.3.3a;
      3> derive serving cell measurement results based on CSI-RS, as described in 5.5.3.3;
1> for each serving cell for which servingCellMO is configured, if the reportConfig associated with at least one measId included in the measIdList within VarMeasConfig contains SINR as trigger quantity and/or reporting quantity:
   2> if the reportConfig contains rsType set to ssb and ssb-ConfigMobility is configured in the servingCellMO:
      3> if the reportConfig contains a reportQuantityRS-Indexes and maxNrofRS-IndexesToReport:
         4> derive layer 3 filtered SINR per beam for the serving cell based on SS/PBCH block, as described in 5.5.3.3a;
      3> derive serving cell SINR based on SS/PBCH block, as described in 5.5.3.3;
   2> if the reportConfig contains rsType set to csi-rs and CSI-RS-ResourceConfigMobility is configured in the servingCellMO:
      3> if the reportConfig contains a reportQuantityRS-Indexes and maxNrofRS-IndexesToReport:
         4> derive layer 3 filtered SINR per beam for the serving cell based on CSI-RS, as described in 5.5.3.3a;
      3> derive serving cell SINR based on CSI-RS, as described in 5.5.3.3;
1> for each measId included in the measIdList within VarMeasConfig:
   . . .
   2> if the reportType for the associated reportConfig is periodical, eventTriggered; or
   2> if the reportType for the associated reportConfig is condTriggerConfig, the measId is within the MCG VarMeasConfig and is indicated in the condExecutionCond or in the condExecutionCondPSCell associated to a condReconfigId in the MCG VarConditionalReconfig (for CHO, CPA, MN-initiated inter-SN CPC, or subsequent CPAC in NR-DC); or
   2> if the reportType for the associated reportConfig is condTriggerConfig, the measId is within the SCG VarMeasConfig and is indicated in the condExecutionCond associated to a condReconfigId in the SCG VarConditionalReconfig (for intra-SN CPC or subsequent CPAC); or
   2> if the reportType for the associated reportConfig is condTriggerConfig, the measId is within the SCG VarMeasConfig and is indicated in the condExecutionCondSCG associated to a condReconfigId in the MCG VarConditionalReconfig (for SN-initiated inter-SN CPC or subsequent CPAC in NR-DC); or
   2> if the reportType for the associated reportConfig is condTriggerConfig, the measId is within the SCG VarMeasConfig and is indicated in the triggerConditionSN associated to a condReconfigurationId in VarConditionalReconfiguration as specified in TS 36.331 [10] (for SN-initiated inter-SN CPC in EN-DC):
      3> if a measurement gap configuration is setup, or
      3> if the UE does not require measurement gaps to perform the concerned measurements:
         4> if s-MeasureConfig is not configured, or
         4> if s-MeasureConfig is set to ssb-RSRP and the NR SpCell RSRP based on SS/PBCH block, after layer 3 filtering, is lower than ssb-RSRP, or
         4> if s-MeasureConfig is set to csi-RSRP and the NR SpCell RSRP based on CSI-RS, after layer 3 filtering, is lower than csi-RSRP:
         5> if the measObject is associated to NR and the rsType is set to csi-rs:
         6> if reportQuantityRS-Indexes and maxNrofRS-IndexesToReport for the associated reportConfig are configured:
         7> derive layer 3 filtered beam measurements only based on CSI-RS for each measurement quantity indicated in reportQuantiyRS-Indexes, as described in 5.5.3.3a;
         6> derive cell measurement results based on CSI-RS for the trigger quantity and each measurement quantity indicated in reportQuantityCell using parameters from the associated measObject, as described in 5.5.3.3;
         5> if the measObject is associated to NR and the rsType is set to ssb:
         6> if reportQuantityRS-Indexes and maxNrofRS-IndexesToReport for the associated reportConfig are configured:
         7> derive layer 3 beam measurements only based on SS/PBCH block for each measurement quantity indicated in reportQuantiyRS-Indexes, as described in 5.5.3.3a;
         6> derive cell measurement results based on SS/PBCH block for the trigger quantity and each measurement quantity indicated in reportQuantityCell using parameters from the associated measObject, as described in 5.5.3.3;
         . . .
         4> if the measRSSI-ReportConfig is configured in the associated reportConfig:
         5> perform the RSSI and channel occupancy measurements on the frequency configured by rmtc-Frequency in the associated measObject;
. . .

### 5.5.3.2 Layer 3 Filtering

The UE shall:
1> for each cell measurement quantity, each beam measurement quantity, each sidelink measurement quantity as needed in clause 5.8.10, for each CLI measurement quantity that the UE performs measurements according to 5.5.3.1, for each candidate L2 U2N Relay UE measurement quantity according to 5.5.3.4, for evaluating the detected NR sidelink U2N Relay UEs according to 5.8.15.3, for evaluating the SyncRef UE according to 5.8.5 and 5.8.6, for evaluating the NR sidelink U2U Relay/Remote UE threshold conditions according to 5.8.16.2 and 5.8.17.2, for evaluating the conditions for selection and reselection of NR sidelink U2U Relay UE according to 5.8.17.3, and for evaluating the detected NR sidelink U2U Relay UEs according to 5.8.17.4:
   2> filter the measured result, before using for evaluation of reporting criteria, for measurement reporting, for U2N/U2U Relay (re)selection evaluation or for evaluating the SyncRef UE, by the following formula:

$${F}_{n} = ( 1 - a ) * {F}_{n - 1} + a * {M}_{n}$$

where
   Mₙ is the latest received measurement result from the physical layer,
   Fₙ is the updated filtered measurement result, that is used for evaluation of reporting criteria, for measurement reporting, for U2N/U2U Relay (re)selection evaluation or for evaluating the SyncRef UE;
   Fₙ₋₁ is the old filtered measurement result, where F₀ is set to M₁ when the first measurement result from the physical layer is received; and for MeasObjectNR, a=½^{(ki/4)}, where kᵢ is the filterCoefficient for the corresponding measurement quantity of the i:th QuantityConfigNR in quantityConfigNR-List, and i is indicated by quantityConfigIndex in MeasObjectNR; for other measurements, a=½^{(k/4)}, where k is the filterCoefficient for the corresponding measurement quantity received by the quantityConfig; for UTRA-FDD, a=½^{(k/4)} where k is the filterCoefficient for the corresponding measurement quantity received by quantityConfigUTRA-FDD in the QuantityConfig;
2> adapt the filter such that the time characteristics of the filter are preserved at different input rates, observing that the filterCoefficient k assumes a sample rate equal to X ms; The value of X is equivalent to one intra-frequency L1 measurement period as defined in TS 38.133 [14] assuming non-DRX operation, and depends on frequency range.
NOTE 1: If k is set to 0, no layer 3 filtering is applicable.
NOTE 2: The filtering is performed in the same domain as used for evaluation of reporting criteria, for measurement reporting, for U2N Relay (re)selection evaluation or for evaluating the SyncRef UE, i.e., logarithmic filtering for logarithmic measurements.
NOTE 3: The filter input rate is implementation dependent, to fulfil the performance requirements set in TS 38.133 [14]. For further details about the physical layer measurements, see TS 38.133 [14].
NOTE 4: For CLI-RSSI measurement, it is up to UE implementation whether to reset filtering upon BWP switch.
NOTE 5: For SSB measurements when multiple altitude range-based ssb-ToMeasure are configured, it is up to UE implementation whether to reset filtering upon entering a different altitude range.

### 5.5.3.3 Derivation of Cell Measurement Results

The network may configure the UE in RRC_CONNECTED to derive RSRP, RSRQ and SINR measurement results per cell associated to NR measurement objects based on parameters configured in the measObject (e.g. maximum number of beams to be averaged and beam consolidation thresholds) and in the reportConfig (rsType to be measured, SS/PBCH block or CSI-RS).

The network may configure the UE in RRC_IDLE or in RRC_INACTIVE to derive RSRP and RSRQ measurement results per cell associated to NR carriers based on parameters configured in measIdleCarrierListNR within VarMeasIdleConfig for measurements performed according to 5.7.8.2a.

The UE shall:
1> for each cell measurement quantity to be derived based on SS/PBCH block:
   2> if nrofSS-BlocksToAverage is not configured in the associated measObject in RRC_CONNECTED or in the associated entry in measIdleCarrierListNR within VarMeasIdleConfig in RRC_IDLE/RRC_INACTIVE; or
   2> if absThreshSS-BlocksConsolidation is not configured in the associated measObject in RRC_CONNECTED or in the associated entry in measIdleCarrierListNR within VarMeasIdleConfig in RRC_IDLE/RRC_INACTIVE; or
   2> if the highest beam measurement quantity value is below or equal to absThreshSS-BlocksConsolidation:
      3> derive each cell measurement quantity based on SS/PBCH block as the highest beam measurement quantity value, where each beam measurement quantity is described in TS 38.215 [9];
   2> else:
      3> derive each cell measurement quantity based on SS/PBCH block as the linear power scale average of the highest beam measurement quantity values above absThreshSS-BlocksConsolidation where the total number of averaged beams shall not exceed nroJSS-BlocksToAverage, and where each beam measurement quantity is described in TS 38.215 [9];
   2> if in RRC_CONNECTED, apply layer 3 cell filtering as described in 5.5.3.2;
1> for each cell measurement quantity to be derived based on CSI-RS:
   2> consider a CSI-RS resource to be applicable for deriving cell measurements when the concerned CSI-RS resource is included in the csi-rs-CellMobility including the physCellId of the cell in the CSI-RS-ResourceConfigMobility in the associated measObject;
   2> if nrofCSI-RS-ResourcesToAverage in the associated measObject is not configured; or
   2> if absThreshCSI-RS-Consolidation in the associated measObject is not configured; or
   2> if the highest beam measurement quantity value is below or equal to absThreshCSI-RS-Consolidation:
      3> derive each cell measurement quantity based on applicable CSI-RS resources for the cell as the highest beam measurement quantity value, where each beam measurement quantity is described in TS 38.215 [9];
   2> else:
      3> derive each cell measurement quantity based on CSI-RS as the linear power scale average of the highest beam measurement quantity values above absThreshCSI-RS-Consolidation where the total number of averaged beams shall not exceed nrofCSI-RS-ResourcesToAverage;
   2> apply layer 3 cell filtering as described in 5.5.3.2.
   . . .

### 5.5.4 Measurement Report Triggering

### 5.5.4.1 General

If AS security has been activated successfully, the UE shall:
1> for each measId included in the measIdList within VarMeasConfig:
   2> if the corresponding reportConfig includes a reportType set to eventTriggered or periodical:
      3> if the corresponding measObject concerns NR:
         4> if the eventA1 or eventA2 is configured in the corresponding reportConfig:
         5> consider only the serving cell to be applicable;
         4> if the eventA3 or eventA5 or eventA3H1 or eventA3H2 or eventA5H1 or eventA5H2 is configured in the corresponding reportConfig:
         5> if a serving cell is associated with a measObjectNR and neighbours are associated with another measObjectNR, consider any serving cell associated with the other measObjectNR to be a neighbouring cell as well;
         . . .
         4> if corresponding reportConfig includes reportType set to periodical; or
         4> for measurement events other than eventA1, eventA2, eventD1, eventD2, eventX2, eventH1 or eventH2:
         5> if useAllowedCellList is set to true:
         6> consider any neighbouring cell detected based on parameters in the associated measObjectNR to be applicable when the concerned cell is included in the allowedCellsToAddModList defined within the VarMeasConfig for this measId;
         5> else:
         6> consider any neighbouring cell detected based on parameters in the associated measObjectNR to be applicable when the concerned cell is not included in the excludedCellsToAddModList defined within the VarMeasConfig for this measId;
      . . .
   2> if the reportType is set to eventTriggered, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):
      3> include a measurement reporting entry within the VarMeasReportList for this measId;
      3> set the numberOfReportsSent defined within the VarMeasReportList for this measId to 0;
      3> include the concerned cell(s) in the cellsTriggeredList defined within the VarMeasReportList for this measId;
      3> if useT312 is set to true in reportConfig for this event:
         4> if T310 for the corresponding SpCell is running; and
         4> if T312 is not running for corresponding SpCell:
         5> start timer T312 for the corresponding SpCell with the value of T312 configured in the corresponding measObjectNR;
      3> initiate the measurement reporting procedure, as specified in 5.5.5;
   2> else if the reportType is set to eventTriggered, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig (a subsequent cell triggers the event):
      3> set the numberOfReportsSent defined within the VarMeasReportList for this measId to 0;
      3> include the concerned cell(s) in the cellsTriggeredList defined within the VarMeasReportList for this measId;
      3> if useT312 is set to true in reportConfig for this event:
         4> if T310 for the corresponding SpCell is running; and
         4> if T312 is not running for corresponding SpCell:
         5> start timer T312 for the corresponding SpCell with the value of T312 configured in the corresponding measObjectNR;
      3> initiate the measurement reporting procedure, as specified in 5.5.5;
   2> if the reportType is set to eventTriggered, and if the corresponding reportConfig includes numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig:
      3> if the VarMeasReportList does not include a measurement reporting entry for this measId (a first cell triggers the event):
         4> include a measurement reporting entry within the VarMeasReportList for this measId;
      3> if the number of cell(s) in the cellsTriggeredList is larger than or equal to numberOfTriggeringCells:
         4> include the concerned cell(s) in the cellsTriggeredList defined within the VarMeasReportList for this measId;
      3> else:
         4> include the concerned cell(s) in the cellsTriggeredList defined within the VarMeasReportList for this measId;
         4> if the number of cell(s) in the cellsTriggeredList is larger than or equal to numberOfTriggeringCells:
         5> set the numberOfReportsSent defined within the VarMeasReportList for this measId to 0;
         5> initiate the measurement reporting procedure, as specified in 5.5.5;
   2> if the reportType is set to eventTriggered and if the leaving condition applicable for this event is fulfiled for one or more of the cells included in the cellsTriggeredList defined within the VarMeasReportList for this measId for all measurements after layer 3 filtering taken during timeToTrigger defined within the VarMeasConfig for this event:
      3> remove the concerned cell(s) in the cellsTriggeredList defined within the VarMeasReportList for this measId;
      3> if reportOnLeave is set to true for the corresponding reporting configuration:
         4> if the corresponding reportConfig does not include numberOfTriggeringCells; or
         4> if the corresponding reportConfig includes numberOfTriggeringCells and a measurement report was previously sent to the network for at least one of the concerned cell(s):
         5> initiate the measurement reporting procedure, as specified in 5.5.5;
      3> if the cellsTriggeredList defined within the VarMeasReportList for this measId is empty:
         4> remove the measurement reporting entry within the VarMeasReportList for this measId;
         4> stop the periodical reporting timer for this measId, if running;
         . . .
   2> if reportType is set to periodical and if a (first) measurement result is available:
      3> include a measurement reporting entry within the VarMeasReportList for this measId;
      3> set the numberOfReportsSent defined within the VarMeasReportList for this measId to 0;
         . . .
      3> else if the reportAmount exceeds 1:
         4> initiate the measurement reporting procedure, as specified in 5.5.5, immediately after the quantity to be reported becomes available for the NR SpCell or for the serving L2 U2N Relay UE (if the UE is a L2 U2N Remote UE);
      3> else (i.e. the reportAmount is equal to 1):
         4> initiate the measurement reporting procedure, as specified in 5.5.5, immediately after the quantity to be reported becomes available for the NR SpCell and for the strongest cell among the applicable cells, or for the NR SpCell and for the strongest L2 U2N Relay UEs among the applicable L2 U2N Relay UEs; or initiate the measurement reporting procedure, as specified in 5.5.5, immediately after the quantity to be reported becomes available for the serving L2 U2N Relay UE and for the strongest cell among the applicable cells, or for the serving L2 U2N Relay UE and for the strongest L2 U2N Relay UEs among the applicable L2 U2N Relay UEs (if the UE is a L2 U2N Remote UE);
      . . .
   2> upon expiry of the periodical reporting timer for this measId:
      3> initiate the measurement reporting procedure, as specified in 5.5.5.
         . . .
            5.5.4.2 Event A1 (Serving Becomes Better than Threshold)

The UE shall:
1> consider the entering condition for this event to be satisfied when condition A1-1, as specified below, is fulfilled;
1> consider the leaving condition for this event to be satisfied when condition A1-2, as specified below, is fulfilled;
1> for this measurement, consider the NR serving cell corresponding to the associated measObjectNR associated with this event.

### Inequality A1-1 (Entering Condition)

$$Ms - Hys > Thresh$$

### Inequality A1-2 (Leaving Condition)

$$Ms + Hys < Thresh$$

The variables in the formula are defined as follows:
Ms is the measurement result of the serving cell, not taking into account any offsets.
Hys is the hysteresis parameter for this event (i.e. hysteresis as defined within reportConfigNR for this event).
Thresh is the threshold parameter for this event (i.e. a1-Threshold as defined within reportConfigNR for this event).
Ms is expressed in dBm in case of RSRP, or in dB in case of RSRQ and RS-SINR.
Hys is expressed in dB.
Thresh is expressed in the same unit as Ms.
   5.5.4.3 Event A2 (Serving Becomes Worse than Threshold)

The UE shall:
1> consider the entering condition for this event to be satisfied when condition A2-1, as specified below, is fulfilled;
1> consider the leaving condition for this event to be satisfied when condition A2-2, as specified below, is fulfilled;
1> for this measurement, consider the serving cell indicated by the measObjectNR associated to this event.
NOTE: If the SCell indicated by the measObjectNR associated to this event is not detectable, then the UE should consider for the value of Ms the lowest value of the value range of the measurement quantity as the SCell measurement.

### Inequality A2-1 (Entering Condition)

$$Ms + Hys < Thresh$$

### Inequality A2-2 (Leaving Condition)

$$Ms - Hys > Thresh$$

The variables in the formula are defined as follows:
Ms is the measurement result of the serving cell, not taking into account any offsets.
Hys is the hysteresis parameter for this event (i.e. hysteresis as defined within reportConfigNR for this event).
Thresh is the threshold parameter for this event (i.e. a2-Threshold as defined within reportConfigNR for this event).
Ms is expressed in dBm in case of RSRP, or in dB in case of RSRQ and RS-SINR.
Hys is expressed in dB.
Thresh is expressed in the same unit as Ms.
   5.5.4.4 Event A3 (Neighbour Becomes Offset Better than SpCell)

The UE shall:
1> consider the entering condition for this event to be satisfied when condition A3-1, as specified below, is fulfilled;
1> consider the leaving condition for this event to be satisfied when condition A3-2, as specified below, is fulfilled;
1> use the SpCell for Mp, Ofp and Ocp.
NOTE 1: The cell(s) that triggers the event has reference signals indicated in the measObjectNR associated to this event which may be different from the NR SpCell measObjectNR.

### Inequality A3—(Entering Condition)

$$Mn + Ofn + Ocn - Hys > Mp + Ofp + Ocp + Off$$

### Inequality A3-2 (Leaving Condition)

$$Mn + Ofn + Ocn + Hys < Mp + Ofp + Ocp + Off$$

The variables in the formula are defined as follows:
Mn is the measurement result of the neighbouring cell, not taking into account any offsets.
Ofn is the measurement object specific offset of the reference signal of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the frequency of the neighbour cell, or cellIndividualOffset as defined within reportConfigNR), and set to zero if not configured for the neighbour cell.
Mp is the measurement result of the SpCell, not taking into account any offsets.
Ofp is the measurement object specific offset of the SpCell (i.e. offsetMO as defined within measObjectNR corresponding to the SpCell).
Ocp is the cell specific offset of the SpCell (i.e. cellIndividualOffset as defined within measObjectNR corresponding to the SpCell), and is set to zero if not configured for the SpCell.
Hys is the hysteresis parameter for this event (i.e. hysteresis as defined within reportConfigNR for this event).
Off is the offset parameter for this event (i.e. a3-Offset as defined within reportConfigNR for this event).
Mn, Mp are expressed in dBm in case of RSRP, or in dB in case of RSRQ and RS-SINR.
Ofn, Ocn, Ofp, Ocp, Hys, Of are expressed in dB.
NOTE 2: The definition of Event A3 also applies to CondEvent A3.
   5.5.4.5 Event A4 (Neighbour Becomes Better than Threshold)

The UE shall:
1> consider the entering condition for this event to be satisfied when condition A4-1, as specified below, is fulfilled;
1> consider the leaving condition for this event to be satisfied when condition A4-2, as specified below, is fulfilled.

### Inequality A4-1 (Entering Condition)

$$Mn + Ofn + Ocn - Hys > Thresh$$

### Inequality A4-2 (Leaving Condition)

$$Mn + Ofn + Ocn + Hys < Thresh$$

The variables in the formula are defined as follows:
Mn is the measurement result of the neighbouring cell or the measurement result of serving PSCell (i.e., in case it is configured as candidate PSCell for CondEvent A4 evaluation) for CHO with candidate SCG(s) case, not taking into account any offsets.
Ofn is the measurement object specific offset of the neighbour cell (i.e. offsetMO as defined within measObjectNR corresponding to the neighbour cell).
Ocn is the measurement object specific offset of the neighbour cell (i.e. cellIndividualOffset as defined within measObjectNR corresponding to the neighbour cell, or cellIndividualOffset as defined within reportConfigNR), and set to zero if not configured for the neighbour cell.
Hys is the hysteresis parameter for this event (i.e. hysteresis as defined within reportConfigNR for this event).
Thresh is the threshold parameter for this event (i.e. a4-Threshold as defined within reportConfigNR for this event).
Mn is expressed in dBm in case of RSRP, or in dB in case of RSRQ and RS-SINR.
Ofn, Ocn, Hys are expressed in dB.
Thresh is expressed in the same unit as Mn.
NOTE: The definition of Event A4 also applies to CondEvent A4.
   5.5.4.6 Event A5 (SpCell Becomes Worse than Threshold1 and Neighbour Becomes Better than Threshold2)

The UE shall:
1> consider the entering condition for this event to be satisfied when both condition A5-1 and condition A5-2, as specified below, are fulfilled;
1> consider the leaving condition for this event to be satisfied when condition A5-3 or condition A5-4, i.e. at least one of the two, as specified below, is fulfilled;
1> use the SpCell for Mp.
NOTE 1: The parameters of the reference signal(s) of the cell(s) that triggers the event are indicated in the measObjectNR associated to the event which may be different from the measObjectNR of the NR SpCell.

### Inequality A5-1 (Entering Condition 1)

$$Mp + Hys < Thresh 1$$

### Inequality A5-2 (Entering Condition 2)

$$Mn + Ofn + Ocn - Hy s > Thresh 2$$

### Inequality A5-3 (Leaving Condition 1)

$$Mp - Hys > Thresh 1$$

### Inequality A54 (Leaving Condition 2)

$$Mn + Ofn + Ocn + Hy s < Thresh 2$$

The variables in the formula are defined as follows:
Mp is the measurement result of the NR SpCell, not taking into account any offsets.
Mn is the measurement result of the neighbouring cell, not taking into account any offsets.
Ofn is the measurement object specific offset of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the neighbour cell, or cellIndividualOffset as defined within reportConfigNR), and set to zero if not configured for the neighbour cell.
Hys is the hysteresis parameter for this event (i.e. hysteresis as defined within reportConfigNR for this event).
Thresh1 is the threshold parameter for this event (i.e. a5-Threshold) as defined within reportConfigNR for this event).
Thresh2 is the threshold parameter for this event (i.e. a5-Threshold2 as defined within reportConfigNR for this event).
Mn, Mp are expressed in dBm in case of RSRP, or in dB in case of RSRQ and RS-SINR.
Ofn, Ocn, Hys are expressed in dB.
Thresh1 is expressed in the same unit as Mp.
Thresh2 is expressed in the same unit as Mn.
NOTE 2: The definition of Event A5 also applies to CondEvent A5.
   5.5.4.7 Event A6 (Neighbour Becomes Offset Better than SCell)

The UE shall:
1> consider the entering condition for this event to be satisfied when condition A6-1, as specified below, is fulfilled;
1> consider the leaving condition for this evert to be satisfied when condition A6-2, as specified below, is fulfilled;
1> for this measurement, consider the (secondary) cell corresponding to the measObjectNR associated to this event to be the serving cell.
NOTE: The reference signal(s) of the neighbour(s) and the reference signal(s) of the SCell are both indicated in the associated measObjectNR.

### Inequality A6-1 (Entering Condition)

$$Mn + Ocn - Hys > Ms + Ocs + Off$$

### Inequality A6-2 (Leaving Condition)

$$Mn + Ocn + Hys < Ms + Ocs + Off$$

The variables in the formula are defined as follows:
Mn is the measurement result of the neighbouring cell, not taking into account any offsets.
Ocn is the cell specific offset of the neighbour cell (i.e. cellIndividualOffset as defined within the associated measObjectNR), and set to zero if not configured for the neighbour cell.
Ms is the measurement result of the serving cell, not taking into account any offsets.
Ocs is the cell specific offset of the serving cell (i.e. cellIndividualOffset as defined within the associated measObjectNR, or cellIndividualOffset as defined within reportConfigNR), and is set to zero if not configured for the serving cell.
Hys is the hysteresis parameter for this event (i.e. hysteresis as defined within reportConfigNR for this event).
Off is the offset parameter for this event (i.e. a6-Offset as defined within reportConfigNR for this event).
Mn, Ms are expressed in dBm in case of RSRP, or in dB in case of RSRQ and RS-SINR.
Ocn, Ocs, Hys, Of are expressed in dB.

### 5.5.5 Measurement Reporting

### 5.5.5.1 General

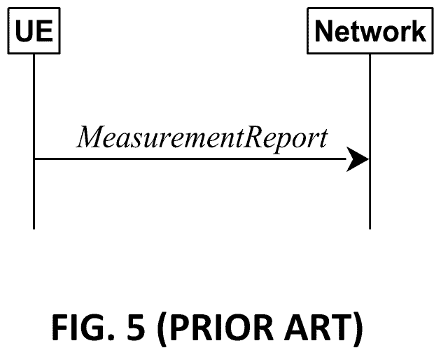

FIG. 5 is a reproduction of FIG. 5.5.5.1-1: Measurement reporting, from 3GPP TS 38.331 V18.1.0 (2024-03) 3GPP.

The purpose of this procedure is to transfer measurement results from the UE to the network. The UE shall initiate this procedure only after successful AS security activation.

For the measId for which the measurement reporting procedure was triggered, the UE shall set the measResults within the MeasurementReport message as follows:
1> set the measId to the measurement identity that triggered the measurement reporting;
1> for each serving cell configured with servingCellMO:
   2> if the reportConfig associated with the measId that triggered the measurement reporting includes rsType:
      3> if the serving cell measurements based on the rsType included in the reportConfig that triggered the measurement report are available:
         4> set the measResultServingCell within measResultServingMOList to include RSRP, RSRQ and the available SINR of the serving cell, derived based on the rsType included in the reportConfig that triggered the measurement report;
   2> else:
      3> if SSB based serving cell measurements are available:
         4> set the measResultServingCell within measResultServingMOList to include RSRP, RSRQ and the available SINR of the serving cell, derived based on SSB;
      3> else if CSI-RS based serving cell measurements are available:
         4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
   2> for each serving cell configured with servingCellMO, include beam measurement information according to the associated reportConfig as described in 5.5.5.2;
1> if the reportConfig associated with the measId that triggered the measurement reporting includes reportAddNeighMeas:
   2> for each measObjectId referenced in the measIdList which is also referenced with servingCellMO, other than the measObjectId corresponding with the measId that triggered the measurement reporting:
      3> if the measObjectNR indicated by the servingCellMO includes the RS resource configuration corresponding to the rsType indicated in the reportConfig:
         4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         4> if the reportConfig associated with the measId that triggered the measurement reporting includes reportQuantityRS-Indexes and maxNrofRS-IndexesToReport:
         5> for each best non-serving cell included in the measurement report:
         6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2, or eventA3H1, or eventA3H2, or eventA4H1, or eventA4H2, or eventA5H1, or eventA5H2:
   2> if the UE is in NE-DC and the measurement configuration that triggered this measurement report is associated with the MCG:
      3> set the measResultServFreqListEUTRA-SCG to include an entry for each E-UTRA SCG serving frequency with the following:
         4> include carrierFreq of the E-UTRA serving frequency;
         4> set the measResultServingCell to include the available measurement quantities that the UE is configured to measure by the measurement configuration associated with the SCG;
         4> if reportConfig associated with the measId that triggered the measurement reporting includes reportAddNeighMeas:
         5> set the measResultServFreqListEUTRA-SCG to include within measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5, or eventA3H1, or eventA3H2, or eventA4H1, or eventA4H2, or eventA5H1, or eventA5H2:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the serving cell measurements based on the rsType included in the reportConfig that triggered the measurement report are available according to the measurement configuration associated with the SCG:
         6> set the measResultServingCell within measResultServFreqListNR-SCG to include RSRP, RSRQ and the available SINR of the serving cell, derived based on the rsType included in the reportConfig that triggered the measurement report;
         4> else:
         5> if SSB based serving cell measurements are available according to the measurement configuration associated with the SCG:
         6> set the measResultServingCell within measResultServFreqListNR-SCG to include RSRP, RSRQ and the available SINR of the serving cell, derived based on SSB;
         5> else if CSI-RS based serving cell measurements are available according to the measurement configuration associated with the SCG:
         6> set the measResultServingCell within measResultServFreqListNR-SCG to include RSRP, RSRQ and the available SINR of the serving cell, derived based on CSI-RS;
         4> if results for the serving cell derived based on SSB are included:
         5> include the ssbFrequency to the value indicated by ssbFrequency as included in the MeasObjectNR of the serving cell;
         4> if results for the serving cell derived based on CSI-RS are included:
         5> include the refFreqCSI-RS to the value indicated by refFreqCSI-RS as included in the MeasObjectNR of the serving cell;
         4> if the reportConfig associated with the measId that triggered the measurement reporting includes reportQuantityRS-Indexes and maxNrofRS-IndexesToReport
         5> for each serving cell configured with servingCellMO, include beam measurement information according to the associated reportConfig as described in 5.5.5.2, where availability is considered according to the measurement configuration associated with the SCG;
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig:
         6> set the measResultNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         7> if the reportConfig associated with the measId that triggered the measurement reporting includes reportQuantityRS-Indexes and maxNrofRS-IndexesToReport:
         8> for each best non-serving cell included in the measurement report:
         9> include beam measurement information according to the associated reportConfig as described in 5.5.5.2, where availability is considered according to the measurement configuration associated with the SCG;
. . .
1> if there is at least one applicable neighbouring cell or candidate L2 U2N Relay UE to report:
   2> if the reportType is set to eventTriggered or periodical:
      3> if the measurement report concerns the candidate L2 U2N Relay UE:
         . . .
      3> else:
         4> set the measResultNeighCells to include the best neighbouring cells up to maxReportCells in accordance with the following:
         5> if the reportType is set to eventTriggered and eventId is not set to eventD1 or eventD2 or eventH1 or eventH2:
         6> include the cells included in the cellsTriggeredList as defined within the VarMeasReportList for this measId;
         5> else:
         6> include the applicable cells for which the new measurement results became available since the last periodical reporting or since the measurement was initiated or reset;
         5> for each cell that is included in the measResultNeighCells, include the physCellId;
         5> if the reportType is set to eventTriggered or periodical:
         6> for each included cell, include the layer 3 filtered measured results in accordance with the reportConfig for this measId, ordered as follows:
         7> if the measObject associated with this measId concerns NR:
         8> if rsType in the associated reportConfig is set to ssb:
         9> set resultsSSB-Cell within the measResult to include the SS/PBCH block based quantity(ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
         8> else if rsType in the associated reportConfig is set to csi-rs:
         9> set resultsCSI-RS-Cell within the measResult to include the CSI-RS based quantity(ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
. . .
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measId;

### ********************************* Next Quotation [3] *********************************

### —MeasurementReport

The MeasurementReport message is used for the indication of measurement results.
Signalling radio bearer: SRB1, SRB3
RLC-SAP: AM
Logical channel: DCCH
Direction: UE to Network

MeasurementReport message

| -- ASN1START | |
|---|---|
| -- TAG-MEASUREMENTREPORT-START | |
| MeasurementReport ::= | SEQUENCE { |
| criticalExtensions | CHOICE { |
| measurementReport | MeasurementReport-IEs, |
| criticalExtensionsFuture | SEQUENCE { } |
| } | |
| } | |
| MeasurementReport-IEs ::= | SEQUENCE { |
| measResults | MeasResults, |
| lateNonCriticalExtension | OCTET STRING |
| OPTIONAL, | |
| nonCriticalExtension | SEQUENCE{ } |

OPTIONAL
}
-- TAG-MEASUREMENTREPORT-STOP
-- ASN1STOP
...

### —MeasConfig

The IE MeasConfig specifies measurements to be performed by the UE, and covers intra-frequency, inter-frequency and inter-RAT mobility as well as configuration of measurement gaps.

MeasConfig information element

-- ASN1START
-- TAG-MEASCONFIG-START

| | |
|---|---|
| MeasConfig ::= | SEQUENCE { |
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
  ...,
  [[
```

| | |
|---|---|
| interFrequencyConfig-NoGap-r16 | ENUMERATED {true} |

```
OPTIONAL -- Need R
  ]],
  [[
```

| | |
|---|---|
| effectiveMeasWindowConfig-r18 | SetupRelease {MeasWindowConfig-r18} |

OPTIONAL -- Need M
]]
}

| | |
|---|---|
| MeasObjectToRemoveList ::= | SEQUENCE (SIZE (1..maxNrofObjectId)) OF MeasObjectId |
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF ReportConfigId |

-- TAG-MEASCONFIG-STOP
-- ASN1STOP
MeasConfig field descriptions
s-MeasureConfig
Threshold for NR SpCell RSRP measurement controlling when the UE is required to perform measurements on non-
serving cells. Choice of ssb-RSRP corresponds to cell RSRP based on SS/PBCH block and choice of csi-RSRP
corresponds to cell RSRP of CSI-RS.
...

### —MeasIdToAddModList

The IE MeasIdToAddModList concerns a list of measurement identities to add or modify, with for each entry the measId, the associated measObjectId and the associated reportConfigId.

MeasIdToAddModList information element

-- ASN1START
-- TAG-MEASIDTOADDMODLIST-START

| | |
|---|---|
| MeasIdToAddModList ::= | SEQUENCE (SIZE (1..maxNrofMeasId)) OF MeasIdToAddMod |
| MeasIdToAddMod ::= | SEQUENCE { |
| measId | MeasId, |
| measObjectId | MeasObjectId, |
| reportConfigId | ReportConfigId |

}
-- TAG-MEASIDTOADDMODLIST-STOP
-- ASN1STOP
...

### —MeasObjectToAddModList

The IE MeasObjectToAddModList concerns a list of measurement objects to add or modify.

MeasObjectToAddModList information element

-- ASN1START
-- TAG-MEASOBJECTTOADDMODLIST-START

| | |
|---|---|
| MeasObjectToAddModList ::= | SEQUENCE (SIZE (1..maxNrofObjectId)) OF |

MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |

...,

| | |
|---|---|
| measObjectEUTRA | MeasObjectEUTRA, |
| measObjectUTRA-FDD-r16 | MeasObjectUTRA-FDD-r16, |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16, |
| measObjectNR-SL-r18 | MeasObjectNR-SL-r18 |

}
}
-- TAG-MEASOBJECTTOADDMODLIST-STOP
-- ASN1STOP
...

### —MeasResults

The IE MeasResults covers measured results for intra-frequency, inter-frequency, inter-RAT mobility and measured results for NR sidelink communication/discovery.

MeasResults information element

-- ASN1START
-- TAG-MEASRESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16, |
| sl-MeasResultsCandRelay-r17 | OCTET STRING -- Contains PC5 SL- |

```
MeasResultListRelay-r17
  }
OPTIONAL,
  ...,
}
```

| | |
|---|---|
| MeasResultServMOList ::= | SEQUENCE (SIZE (1..maxNrofServingCells)) OF MeasResultServMO |
| MeasResultServMO ::= | SEQUENCE { |
| servCellId | ServCellIndex, |
| measResultServingCell | MeasResultNR, |
| measResultBestNeighCell | MeasResultNR |

OPTIONAL,
...
}

| | |
|---|---|
| MeasResultListNR ::= | SEQUENCE (SIZE (1..maxCellReport)) OF MeasResultNR |
| MeasResultNR ::= | SEQUENCE { |
| physCellId | PhysCellId |

OPTIONAL,

| | |
|---|---|
| measResult | SEQUENCE { |
| cellResults | SEQUENCE{ |
| resultsSSB-Cell | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS-IndexList |

```
OPTIONAL
    }
OPTIONAL
  },
  ...,
}
...
```

| | |
|---|---|
| MeasQuantityResults ::= | SEQUENCE { |
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}
...

| | |
|---|---|
| ResultsPerSSB-IndexList::= | SEQUENCE (SIZE (1..maxNrofIndexesToReport2)) OF |

ResultsPerSSB-Index

| | |
|---|---|
| ResultsPerSSB-Index ::= | SEQUENCE { |
| ssb-Index | SSB-Index, |
| ssb-Results | MeasQuantityResults |

OPTIONAL
}

| | |
|---|---|
| ResultsPerCSI-RS-IndexList::= | SEQUENCE (SIZE (1..maxNrofIndexesToReport2)) OF |

ResultsPerCSI-RS-Index

| | |
|---|---|
| ResultsPerCSI-RS-Index ::= | SEQUENCE { |
| csi-RS-Index | CSI-RS-Index, |
| csi-RS-Results | MeasQuantityResults |

OPTIONAL
}
...
-- TAG-MEASRESULTS-STOP
-- ASN1STOP

MeasResultNR field descriptions

cellResults
Cell level measurement results.
physCellId
The physical cell identity of the NR cell for which the reporting is being performed.
resultsSSB-Cell
Cell level measurement results based on SS/PBCH related measurements.
resultsSSB-Indexes
Beam level measurement results based on SS/PBCH related measurements.
resultsCSI-RS-Cell
Cell level measurement results based on CSI-RS related measurements.
resultsCSI-RS-Indexes
Beam level measurement results based on CSI-RS related measurements.
rsIndexResults
Beam level measurement results.

MeasResults field descriptions

measId
Identifies the measurement identity for which the reporting is being performed.
measQuantityResults
The value sinr is not included when it is used for LogMeasReport-r16.
measResultListNR
List of measured results for the maximum number of reported best cells for an NR measurement identity.
measResultNR
Measured results of an NR cell.
measResultServingMOList
Measured results of measured cells with reference signals indicated in the serving cell measurement objects including
measurement results of SpCell, configured SCell(s) and best neighbouring cell within measured cells with reference
signals indicated in on each serving cell measurement object. If the sending of the MeasurementReport message is
triggered by a measurement configured by the field sl-ConfigDedicatedForNR received within an E-UTRA
RRCConnectionReconfiguration message (i.e. CBR measurements), this field is not applicable and its contents is
ignored by the network.
. . .

### —ReportConfigNR

The IE ReportConfigNR specifies criteria for triggering of an NR measurement reporting event or of a CHO, CPA or CPC event or of an L2 U2N relay measurement reporting event. For events labelled AN with N equal to 1, 2 and so on, measurement reporting events and CHO, CPA or CPC events are based on cell measurement results, which can either be derived based on SS/PBCH block or CSI-RS.
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;

...

ReportConfigNR information element

-- ASN1START
-- TAG-REPORTCONFIGNR-START

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16, |
| rxTxPeriodical-r17 | RxTxPeriodical-r17, |
| reportOnScellActivation-r18 | ReportOnScellActivation-r18 |

}
}
...

| | |
|---|---|
| EventTriggerConfig ::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
        },
        ...,
      ...
    },
...
}
...
```

| | |
|---|---|
| CellIndividualOffsetList-r18 ::= | SEQUENCE { |
| physCellId-r18 | PhysCellId, |
| cellIndividualOffset-r18 | Q-OffsetRangeList |

}
-- TAG-REPORTCONFIGNR-STOP
-- ASN1STOP

EventTriggerConfig field descriptions

a3-Offset/a6-Offset
Offset value(s) to be used in NR measurement report triggering condition for event a3/a6. The actual value is field value
* 0.5 dB.
aN-ThresholdM
Threshold value associated to the selected trigger quantity (e.g. RSRP, RSRQ, SINR) per RS Type (e.g. SS/PBCH
block, CSI-RS) to be used in NR measurement report triggering condition for event number aN. If multiple thresholds
are defined for event number aN, the Thresholds are differentiated by M. In the same eventA5, eventA5H1, eventA5H2,
the network configures the same quantity for the MeasTriggerQuantity of the a5-Threshold1 and for the
MeasTriggerQuantity of the a5-Threshold2.
channelOccupancyThreshold
RSSI Threshold which is used for channel occupancy evaluation.
timeToTrigger
Time during which specific criteria for the event needs to be met in order to trigger a measurement report.
. . .

### —ReportConfigToAddModList

The IE ReportConfigToAddModList concerns a list of reporting configurations to add or modify.

ReportConfigToAddModList information element

-- ASN1START
-- TAG-REPORTCONFIGTOADDMODLIST-START

| | |
|---|---|
| ReportConfigToAddModList ::= | SEQUENCE (SIZE (1..maxReportConfigId)) OF ReportConfigToAddMod |
| ReportConfigToAddMod ::= | SEQUENCE { |
| reportConfigId | ReportConfigId, |
| reportConfig | CHOICE { |
| reportConfigNR | ReportConfigNR, |

...,

| | |
|---|---|
| reportConfigInterRAT | ReportConfigInterRAT, |
| reportConfigNR-SL-r16 | ReportConfigNR-SL-r16 |

}
}
-- TAG-REPORTCONFIGTOADDMODLIST-STOP
-- ASN1STOP

### ********************************* End of Quotation [3] ********************************

The current Layer 3 (L3) handover mechanism relies on a tailored measurement configuration which utilizes measurement objects, report configurations, and measurement identities to configure the frequencies and cells for a User Equipment (UE) to measure. The UE first measures the configured frequencies and cells, then reports the measurement results to a Network (NW), when the measurement results fulfill the report triggering conditions. The NW may reconfigure the UE to perform handover according to the triggered event type and the measurement results. The mechanism works well but is still limited to a reactive method. With the lower coverage of higher frequency, handover may occur more frequently and thus a more proactive method may be pursued. Currently, for Artificial Intelligence/Machine Learning (AI/ML) mobility enhancements, Radio Resource Management (RRM) measurement prediction, Radio Link Failure (RLF)/Handover Failure (HoF) prediction and measurement event prediction are studied. For RRM measurement prediction, the UE may predict measurement results of future time instances or measurement results of another cell based on historical measurements and include the predicted measurements in a measurement report. For RLF/HoF prediction, the UE may predict the chances of RLF/HoF happening within a time window (or period) before RLF/HoF actually happens. For measurement event prediction, the UE may predict the chances of a measurement event (e.g., Event A3) happening (or triggering a report, fulfilling the entering and/or leaving condition) within a time window (or period), and send a measurement report to the NW. With the assistance of AI/ML models, the UE may proactively react to potential radio problems and enhance the handover performance. Redundant measurements may also be reduced to save resources (e.g., measurement gaps, UE power).

In the latest NR release 18 (e.g., [3] 3GPP TR 38.331 V18.0.0 (2023-12) 3GPP), the NW provides a measurement configuration, and the UE performs measurement and measurement reporting based on the configuration. The measurement configuration includes measurement object(s), report configuration(s), and measurement identity(ies).

A configuration of a measurement object indicates the time of frequency of the cells to measure. A report configuration indicates the conditions for the UE to send the measurement results to the NW. A configuration of a measurement identity associates a measurement object with a report configuration.

The UE measures the serving cell(s) and cell(s) associated with report configuration(s) when there is at least one report configuration associated with a measurement identity and conditions such as measurement gaps or threshold restrictions are met.

The UE may initiate the measurement reporting procedure and send a measurement report to the NW periodically, e.g., upon expiry/expiration of a periodical reporting timer or if a (first) measurement result is available, or based on triggering a measurement event.

For a measurement report sent (or triggered) based on a measurement event, when the measurement fulfills conditions of the measurement event, the UE includes the measurement result(s) of the concerned cell(s) in the measurement report. The measurement result(s) may be (or derived from) the latest result available during the time from the initiation of the measurement reporting procedure to the transmission of the measurement report. The measurement result(s) included in the measurement report fulfills the triggering condition of the measurement event that sent (or triggered) the report. The measurement identity is included in the measurement report to inform the NW about the details of the report (e.g., which event is the trigger of the measurement report).

In NR release 19, several AI/ML enhancements to mobility have been studied as study items. The enhancements include prediction of a measurement event. The UE may predict a measurement event to happen (or trigger a report, fulfill the entering and/or leaving condition) within a time window (or period).

The prediction may be an indirect prediction, where the UE may predict the current and/or future measurement results of one or more cells, based on current and/or historical measurement results of one or more cells, and evaluate the condition(s) for a measurement event (e.g., if the entering and/or leaving condition is fulfilled during timeToTrigger).

The prediction may be a direct prediction, where the UE may predict the chances of a measurement event (e.g., Event A3) happening (or triggering a report, fulfilling the entering and/or leaving condition) within a time window (or period), based on current and/or historical measurement results of one or more cells, without predicting the measurements at the expected triggering time of the event.

When a measurement event is predicted (or triggered), the UE may trigger and/or send a measurement report to the NW.

For measurement event prediction (e.g., direct prediction), at the time when a measurement event is predicted (or triggered), the UE may not have the corresponding measurement results at the expected event trigger time. For example, when the UE predicts that Event A3 may happen within the next n time instances, the UE may not have the measurement results of the concerned cell(s) (e.g., serving cell(s), best non-serving cell(s), neighboring/neighbouring cell(s)) of the next n time instances. Therefore, the currently available measurement results for the concerned cell(s) may not yet fulfill the conditions for the predicted measurement event.

For measurement event prediction (e.g., direct prediction, indirect prediction), at the time when a measurement event is predicted (or triggered), the UE may not have the corresponding measurement result(s) at the expected event trigger time for the cell(s) that are not predicted. For example, when the UE predicts that Event A3 may happen, the UE may have the measurement result(s) for the concerned cell(s) and/or applicable neighboring cell(s) (e.g., when measurement event is predicted (or triggered) indirectly). However, the UE may not have the measurement result(s) for the best neighbor/neighbour cell(s) per frequency (e.g., on the concerned serving frequency). Thus, the UE may not be able to include the measurement result(s) for the best neighbor cell(s) per frequency (e.g., on the concerned serving frequency) in the measurement report sent (or triggered) based on measurement event prediction, which is critical in the multi-carrier handover scenario.

The enhancements also include prediction of future measurement results and measurement results of a frequency and/or cell/beam not measured. The UE and/or NW may predict the measurements of a cell/beam based on actual measurements. The actual measurements may be measurements measured and/or collected by the UE.

To at least solve one or more of the issue(s) described above, at least some method(s) described below could be considered.

Enhancement(s) or modification(s) may be made to the current procedure of measurement and/or measurement reporting (e.g., [3] 3GPP TR 38.331 V18.0.0 (2023-12) 3GPP). The UE may perform measurement(s) and/or RRM measurement prediction according to NW configuration, and/or predict the happening (or triggering a report, fulfilling the entering and/or leaving condition) of a measurement event. When (or in response to) a measurement event is (or being) predicted (or triggered), the UE may send an enhanced (or modified) measurement report to the NW. The enhanced (or modified) measurement report may be compared with the current (or legacy) measurement report (e.g., [3] 3GPP TR 38.331 V18.0.0 (2023-12) 3GPP).

For example, a first (type of) measurement report (e.g., the current or legacy measurement report (e.g., [3] 3GPP TR 38.331 V18.0.0 (2023-12) 3GPP)) may be triggered by the UE based on a first measurement event. The UE may trigger the first (type of) measurement report based on (actual) measurement result(s) (e.g., via actual UE measurement, without prediction, without performing or activating AI/ML functionality). A second (type of) measurement report (e.g., the enhanced or modified measurement report) may be triggered by the UE based on a second measurement event. The UE may trigger the second (type of) measurement report based on measurement event prediction and/or predicted measurement (e.g., with performing or activating AI/ML functionality). The first and the second measurement events may be the same. The first and the second measurement events may be different. The first and the second measurement events may be differentiated based on whether AI/ML functionality and/or prediction is involved. For example, the first measurement event may be event A3. The second measurement event may be an A3-like event but with prediction.

The enhancement(s) or modification(s) may include one or more of the concepts (or examples) described below, and/or one or more of the concepts (or examples) may be combined:

Concept A: at least some cell(s) and/or measurement result(s) is not included (or could be absent) in a measurement report. The report may be sent (or triggered) based on measurement event prediction (e.g., the second (type of) measurement report). (Me at least some cell(s) and/or measurement result(s) is included (or mandatory) in a measurement report sent (or triggered) based on actual measurement (e.g., the first (type of) measurement report)).

Concept B: the UE could predict at least some measurement result(s) based on RRM measurement prediction and/or include the at least some measurement result(s) in the measurement report. The report may be sent (or triggered) based on measurement event prediction (e.g., the second (type of) measurement report)

For example, the capability/availability/applicability/configuration/activation of measurement event prediction and RRM prediction may be separate.

For example, the UE may provide (or indicate) a first capability for (or related to) measurement event prediction. The UE may provide (or indicate) a second capability for (or related to) RRM prediction. The first capability and the second capability may be different (e.g., considered as different capabilities). The first capability and the second capability may be included in the same message or signaling.

For example, the UE may provide (or indicate) a first availability for (or related to) measurement event prediction. The UE may provide (or indicate) a second availability for (or related to) RRM prediction. The first availability and the second availability may be different (e.g., considered as different availability). The first availability and the second availability may be included in the same message or signaling.

For example, the UE may provide (or indicate) a first applicability for (or related to) measurement event prediction. The UE may provide (or indicate) a second applicability for (or related to) RRM prediction. The first applicability and the second applicability may be different (e.g., considered as different applicability). The first applicability and the second applicability may be included in the same message or signaling.

For example, the UE may receive a first configuration for (or related to) measurement event prediction. The UE may receive a second configuration for (or related to) RRM prediction. The first configuration and the second configuration may be different (e.g., considered as different configurations). The first configuration and the second configuration may be included in the same message or signaling (e.g., RRC reconfiguration).

For example, the UE may receive a first activation for (or related to) measurement event prediction. The UE may receive a second activation for (or related to) RRM prediction. The first activation and the second activation may be different (e.g., considered as different activations). The first activation and the second activation may be included in the same message or signaling (e.g., RRC reconfiguration).

The UE may include the at least some measurement result(s) based on its capability/availability/applicability/configuration/activation status of RRM measurement prediction (e.g., perform RRM measurement prediction when (or in response to) it is (or being) capable/available/applicable/configured/activated).

For example, the UE may determine whether to include at least some measurement result(s) in a measurement report that is triggered based on measurement event prediction based on whether the UE has (the related or concerned) measurement result(s) available, whether the UE has (or could) predict(ed) (the related to concerned) measurement result(s), and/or the status of RRM prediction of the UE.

For example, the UE may (determine to) include at least some measurement result (e.g., based on RRM prediction) if (at least) the UE is capable of RRM prediction, the UE is configured with RRM prediction, the functionality of RRM prediction of the UE is available, and/or the functionality of RRM prediction of the UE is activated.

For example, the UE may (determine to) not include the at least some measurement result (e.g., based on RRM prediction) if (at least) the UE is not capable of RRM prediction, the UE is not configured with RRM prediction, the functionality of RRM prediction of the UE is not available, and/or the functionality of RRM prediction of the UE is not activated.

For example, the UE may include the at least some measurement result(s) regardless of its configuration/activation status of RRM prediction (e.g., perform RRM measurement prediction even when (or in response to) it is (or being) not activated or configured).

For example, the UE may include the at least some measurement result (e.g., based on RRM prediction) regardless of whether the UE is capable of RRM prediction, whether the UE is configured with RRM prediction, whether the functionality of RRM prediction of the UE is available, and/or whether the functionality of RRM prediction of the UE is activated.

For example, the UE may include the at least some measurement result (e.g., based on RRM prediction) even when the UE is not configured with RRM prediction, and/or the functionality of RRM prediction of the UE is not activated.

For example, NW may ensure that the (related or concerned) RRM measurement prediction is configured and/or activated when (or in response to) the (related or concerned) measurement event prediction is (or being) configured and/or activated.

For example, the measurement event prediction may be performed when (or in response to) the (related or concerned) RRM measurement is (or being) capable/available/applicable/configured/activated.

For example, the capability/availability/applicability/configuration/activation of measurement event prediction and RRM prediction may be associated.

For example, the UE may provide (or indicate) an indication for (or related to) capability of measurement event prediction and capability of RRM prediction. The indication may indicate that the UE is capable of a functionality of measurement event prediction and a functionality of RRM prediction.

For example, the UE may provide (or indicate) an indication for (or related to) availability of measurement event prediction and availability of RRM prediction. The indication may indicate that a functionality of measurement event prediction and a functionality of RRM prediction are (both) available.

For example, the UE may provide (or indicate) an indication for (or related to) applicability of measurement event prediction and applicability of RRM prediction. The indication may indicate that a functionality of measurement event prediction and a functionality of RRM prediction are (both) applicable.

For example, the UE may receive a configuration for (or related to) measurement event prediction and RRM prediction. The configuration may be associated to measurement event prediction and RRM prediction.

For example, the UE may receive an activation for (or related to) measurement event prediction and RRM prediction. The activation may activate a functionality of measurement event prediction and a functionality of RRM prediction.

Concept C: at least some of the latest available measurement result(s) is included in a measurement report. The report may be sent (or triggered) based on measurement event prediction, e.g., regardless of whether the measurement result(s) fulfill the condition of the predicted event. For example, the latest available measurement result(s) may not reflect the radio conditions at the predicted time of the predicted measurement event.

Concept D: at least some of the available measurement result(s) from multiple time instances are included in a measurement report. The report may be sent (or triggered) based on measurement event prediction. The multiple time instances may include past and/or future time instances (e.g., from the last measurement report). The report may assist decision making at the NW-side.

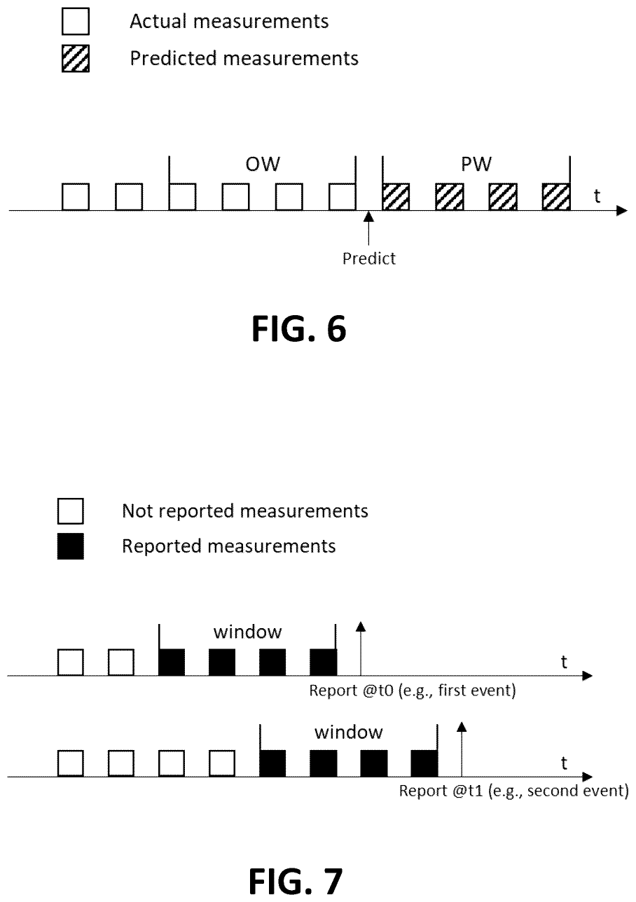

For the NW-sided model, RRM prediction is performed by the network, predicting future measurements and make decisions based on current measurements collected from the UE. An example is shown in FIG. 6 about how an AI model for RRM prediction works. As shown in the figure, an Observation Window (OW) may be a time window where measurements are used as input to the AI model, and a Prediction Window (PW) may be a time window where the AI model can predict the measurement results.

For an AI model at the NW-side, the inputs for the AI model have to be collected from the UE. Based on the current mechanism, only the latest measurement result may be included in a measurement report. And the NW may need to configure a dense measurement report to collect measurement results of multiple time instances.

To enhance the measurement report for NW-side model prediction, the UE may be configured to report measurement results at multiple time instances in a single measurement. However, if the UE determines to include the measurement results freely, the measurement report may include results that are not helpful for NW-side prediction (e.g., measurements before the OW may be outdated for prediction).

To at least solve the issue, when the UE (is configured to) include multiple measurement results at multiple time instances (e.g., for a cell) in a measurement report, the UE may be restricted (or limited) to include measurement results within a time window. An example is shown in FIG. 7. For example, the UE may include measurement results of the time instances within the time window before and at the time of reporting and/or event triggering. The UE may not (be allowed to) include measurement results of the time instances outside the time window.

At least one or more of the concepts above may be applied to (1) serving cell(s), (2) best neighbor cell(s) per frequency (e.g., on the concerned serving frequency), and/or (3) neighboring cell(s). The concepts may be applied to multiple cells. Different concepts (or examples) may be applied to different cells.

To prevent confusion at the NW-side, differentiation may be needed between measurement report(s) sent (or triggered) based on measurement event prediction and actual measurements. For example, the UE may indicate to the NW (whether) a measurement report is sent (or triggered) based on measurement event prediction (or not). For another example, the UE may indicate to the NW (whether) a measurement report is sent (or triggered) based on actual measurements (or not). For example, the UE may indicate to the NW (whether) a measurement report is sent (or triggered) based on measurement event prediction or actual measurement.

One or more methods (or examples) below may be used to enhance or modify a measurement report. The information element(s) or field(s) described below may be included, in whole or in part, in the measurement report or measurement configuration. The cell(s), measurement configuration(s), measurement report(s) may be associated with (only) a Master Cell Group (MCG) or (only) a Secondary Cell Group (SCG).

One or more method(s) (or examples) described below may be at least used for Concept A:
For example, the UE may set an Identification/Identity (ID) of a serving cell (e.g., servCellId) within an information element or field in the measurement report (e.g., measResultServingMOList) to include (only) some of the serving cell(s). The cell(s) may be concerned with the predicted (or triggered) measurement event.
For example, the UE may set the measurement result of a serving cell (e.g., measResultServingCell) within an information element or field in the measurement report (e.g., measResultServingMOList) to include Reference Signal Received Power (RSRP), Reference Signal Received Quality (RSRQ) and/or Singal-to-Interference-Plus-Noise-Ratio (SINR) of (only) some of the serving cell(s). The cell(s) may be concerned with the predicted (or triggered) measurement event.
For example, the cell(s) included in the measurement report (or concerned with the predicted (or triggered) measurement event) may be a predicted cell by the UE (or a cell (predicted) based on the measurement event prediction functionality).
For example, the cell(s) included in the measurement report (or concerned with the predicted (or triggered) measurement event) may be a serving cell whose measurement result is better (or expected/predicted to be better) than a best neighbor cell (or neighboring cell), of a same frequency.
For example, the UE may not set the ID of a serving cell (e.g., servCellId) within an information element or field in the measurement report (e.g., measResultServingMOList) to not include some of the serving cell(s). The cell(s) may be not concerned with the predicted (or triggered) measurement event.
For example, the UE may not set the measurement result of a serving cell (e.g., measResultServingCell) within an information element or field in the measurement report (e.g., measResultServingMOList) to not include RSRP, RSRQ, and/or SINR of some of the serving cell(s).
For example, the cell(s) not included in the measurement report may be a serving cell whose measurement result is worse (or expected/predicted to be worse) than a best neighbor cell (or neighboring cell), of a same frequency.
For example, the UE may set the ID of a best neighbor cell of a frequency (e.g., physCellId) within an information element or field in the measurement report (e.g., measResultServingMOList) to include (only) some of the best neighbor cell(s) of a frequency.
For example, the UE may set the measurement result of a best neighbor cell of a frequency (e.g., measResultBestNeighCell) within an information element or field in the measurement report (e.g., measResultServingMOList) to include RSRP, RSRQ, and/or SINR of (only) some of the best neighbor cell(s) of a frequency.
For example, the cell(s) included in the measurement report may be a best neighbor cell of a frequency whose measurement result is better (or expected/predicted to be better) than a serving cell, of a same frequency.
For example, the UE may not set the ID of a best neighbor cell of a frequency (e.g., physCellId) within an information element or field in the measurement report (e.g., measResultServingMOList) to not include some of the best neighbor cell(s) of a frequency.
For example, the UE may not set the measurement result of a best neighbor cell of a frequency (e.g., measResultBestNeighCell) within an information element or field in the measurement report (e.g., measResultServingMOList) to not include RSRP, RSRQ, and/or SINR of some of the best neighbor cell(s) of a frequency.
For example, the cell(s) not included in the measurement report may be a best neighbor cell of a frequency whose measurement result is worse (or expected/predicted to be worse) than a serving cell, of a same frequency.
For example, the UE may set an information element or field (e.g., measResultNeighCells) to include (only) some of the best neighboring cells up to a configured number (e.g., maxReportCells). The cell(s) may be concerned with the predicted (or triggered) measurement event.
For example, the UE may for some (neighboring) cell(s) that is included in the information element or field (e.g., measResultNeighCells), include the id of the cell (e.g., physCellId).
For example, the UE may for some included (neighboring) cell(s), include the measurement result in accordance with the report configuration (e.g., reportConfig) for this measurement identity (e.g., measId).
For example, the UE may set the measurement result of a (neighboring) cell (e.g., resultsSSB-Cell, resultsCSI-RS-Cell) within an information element or field (e.g., measResult) to include the Synchronization Signal (SS)/Physical Broadcast Channel (PBCH) block (i.e., SSB) (or Channel State Information Reference Signal (CSI-RS)) based quantity(ies) indicated in an information element or field (e.g., reportQuantityCell) within the concerned report configuration (e.g., reportConfig), in decreasing order of the sorting quantity.
For example, the cell(s) included in the measurement report (or concerned with the predicted (or triggered) measurement event) may be a predicted cell by the UE (or a cell (predicted) based on the measurement event prediction functionality).
For example, the UE may not set an information element or field (e.g., measResultNeighCells) to not include some of the best neighboring cells up to a configured number (e.g., maxReportCells). The cell(s) may be not concerned with the predicted (or triggered) measurement event.
For example, the UE may for some cell(s) that is included in the information element or field (e.g., measResultNeighCells), not include the id of the cell (e.g., physCellId).
For example, the UE may, for some included cell(s), not include the measurement result in accordance with the report configuration (e.g., reportConfig) for this measurement identity (e.g., measId).
For example, the UE may not set the measurement result of a neighboring cell (e.g., resultsSSB-Cell, resultsCSI-RS-Cell) within an information element or field (e.g., measResult) to not include the SS/PBCH block (or CSI-RS) based quantity(ies) indicated in an information element or field (e.g., reportQuantityCell) within the concerned report configuration (e.g., reportConfig), in decreasing order of the sorting quantity.
For example, the measurement report may be the first (type of) measurement report.
For example, the measurement report may be the second (type of) measurement report.
For example, the measurement report may not be the first (type of) measurement report.
For example, the measurement report may not be the second (type of) measurement report.

One or more method(s) (or examples) described below may be at least used for Concept B:
For example, the UE may obtain predicted measurement result(s) based on another AI/ML functionality (e.g., RRM measurement prediction, measurement event prediction, RLF/HoF prediction).
For example, the UE may perform (or trigger) another AI/ML functionality (e.g., RRM measurement prediction, measurement event prediction, RLF/HoF prediction) to obtain the predicted measurement result(s), when (or in response to) the AI/ML functionality is (or being) capable/available/applicable/configured/activated, or when (or in response to) the AI/ML functionality is (or being) not capable/available/applicable/configured/activated.
For example, the UE may perform (or trigger) the AI/ML functionality (e.g., RRM measurement prediction, measurement event prediction, RLF/HoF prediction) when (or in response to) an event entering condition (or leaving condition) is (or being) (predicted to be) fulfilled, when (or in response to) the UE sets (or setting) or includes (or including) a measurement result when (or in response to) there is (or being) no measurement result available (for a time instance) or when (or in response to) the UE predicts (or predicting) a measurement event happening (or triggering a report).
For example, when (or in response to) the UE performs (or performing) or triggers (or triggering) the AI/ML functionality (e.g., RRM measurement prediction, measurement event prediction, RLF/HoF prediction), the UE may obtain (future) measurement result(s) for the cell(s) included in the measurement report (or concerned with the predicted (or triggered) measurement event, e.g., serving cells, neighboring cells), cell(s) configured by the NW (e.g., in a RRCReconfiguration message) and/or cell(s) that may assist the L3 mobility decision (e.g., applicable neighboring cell(s), best neighbor cell per frequency).
For example, the UE may set the measurement result of a serving cell (e.g., measResultServingCell) within an information element or field in the measurement report (e.g., measResultServingMOList) to include RSRP, RSRQ, and/or SINR of some of the serving cell(s).
For example, the UE may set the measurement result of a best neighbor cell of a frequency (e.g., measResultBestNeighCell) within an information element or field in the measurement report (e.g., measResultServingMOList) to include RSRP, RSRQ, and/or SINR of some of the best neighbor cell(s) of a frequency.
For example, the UE may for some included (neighboring) cell(s), include the measurement result in accordance with the report configuration (e.g., reportConfig) for this measurement identity (e.g., measId).
For example, the UE may set the measurement result of a (neighboring) cell (e.g., resultsSSB-Cell, resultsCSI-RS-Cell) within an information element or field (e.g., measResult) to include the SS/PBCH block (or CSI-RS) based quantity(ies) indicated in an information element or field (e.g., reportQuantityCell) within the concerned report configuration (e.g., reportConfig), in decreasing order of the sorting quantity.
For example, the measurement result(s) may refer to measurement result(s) predicted based on an AI/ML functionality (e.g., RRM measurement prediction, measurement event prediction, RLF/HoF prediction).
For example, the AI/ML functionality may be a first AI/ML functionality.
For example, the other/another AI/ML functionality may be a second AI/ML functionality.
For example, the first AI/ML functionality and the second AI/ML functionality may be different.
For example, the first AI/ML functionality and the second AI/ML functionality may be the same.
For example, the first and/or the second AI/ML functionality may be (or comprise) RRM (measurement) prediction, measurement event prediction, RLF prediction, and/or HoF prediction.

One or more method(s) (or examples) described below may be at least used for Concept C:
For example, the UE may set the measurement result of a serving cell (e.g., measResultServingCell) within an information element or field in the measurement report (e.g., measResultServingMOList) to include RSRP, RSRQ, and/or SINR of some of the serving cell(s).
For example, the UE may set the measurement result of a best neighbor cell of a frequency (e.g., measResultBestNeighCell) within an information element or field in the measurement report (e.g., measResultServingMOList) to include RSRP, RSRQ, and/or SINR of some of the best neighbor cell(s) of a frequency.
For example, for some included (neighboring) cell(s), the UE may include the measurement result in accordance with the report configuration (e.g., reportConfig) for this measurement identity (e.g., measId).
For example, the UE may set the measurement result of a (neighboring) cell (e.g., resultsSSB-Cell, resultsCSI-RS-Cell) within an information element or field (e.g., measResult) to include the SS/PBCH block (or CSI-RS) based quantity(ies) indicated in an information element or field (e.g., reportQuantityCell) within the concerned report configuration (e.g., reportConfig), in decreasing order of the sorting quantity.
For example, the measurement result(s) may be (or comprise) the latest available measurement result(s) at the time when (or in response to) a measurement event is (or being) predicted (or triggered), an event entering (or leaving) condition is fulfilled, a measurement report is transmitted.
For example, the measurement result(s) may not fulfil the entering condition of the event (e.g., for the case that the measurement report is triggered based on the entering condition of the event).
For example, the measurement result(s) may not fulfil the leaving condition of the event (e.g., for the case that the measurement report is triggered based on the leaving condition of the event).
For example, the measurement report may be the first (type of) measurement report.
For example, the measurement report may be the second (type of) measurement report.
For example, the measurement report may not be the first (type of) measurement report.
For example, the measurement report may not be the second (type of) measurement report.

One or more method(s) (or examples) described below may be at least used for Concept D:
For example, the UE may set the measurement result of a serving cell (e.g., measResultServingCell) within an information element or field in the measurement report (e.g., measResultServingMOList) to include RSRP, RSRQ, and/or SINR of some of the serving cell(s).
For example, the UE may set the measurement result of a best neighbor cell of a frequency (e.g., measResultBestNeighCell) within an information element or field in the measurement report (e.g., measResultServingMOList) to include RSRP, RSRQ, and/or SINR of some of the best neighbor cell(s) of a frequency.
For example, the UE may for some included (neighboring) cell(s), include the measurement result in accordance with the report configuration (e.g., reportConfig) for this measurement identity (e.g., measId).
For example, the UE may set the measurement result of a (neighboring) cell (e.g., resultsSSB-Cell, resultsCSI-RS-Cell) within an information element or field (e.g., measResult) to include the SS/PBCH block (or CSI-RS) based quantity(ies) indicated in an information element or field (e.g., reportQuantityCell) within the concerned report configuration (e.g., reportConfig), in decreasing order of the sorting quantity.
For example, the measurement result(s) may refer to measurement results of multiple time instances (within a time window).
The measurement result(s) may include actual measurements and/or predicted measurements. The measurement result(s) may include new measurements available since the last periodical or event triggered reporting or since the measurement was initiated or reset.
The multiple time instances (within a time window) may be configured by the NW (e.g., through RRC reconfiguration). The multiple time instances (within a time window) may include time instances before, at and/or after the time a measurement event is predicted (or triggered), the time of an event entering (or leaving) condition fulfilled, the time of a measurement report transmission, the time of the last transmitted (periodical or event triggered) measurement report.
For example, the UE may receive a configuration (and/or be configured) to include measurement results at multiple time instances (e.g., for a cell, for a beam) in a measurement report. The NW may provide a configuration (or indication) indicating the UE to include measurement results at multiple time instances (e.g., for a cell, for a beam) in a measurement report. The measurement result(s) and/or the measurement report may be used (by the NW) for an AI/ML functionality (e.g., RRM measurement prediction, NW-side prediction, cell prediction, and/or beam prediction).
The configuration (or indication) may indicate that the measurement results for which (or what) cell(s) should be provided (or included). The cell(s) may be (or comprise) a serving cell, a neighbor cell, a PCell, a SCell, a neighbor cell on serving MO (measurement object), a configured cell, an indicated cell, an associated cell, an applicable cell, and/or a detected cell. When the UE (is configured to) include measurement results at multiple time instances in a measurement report, the UE may include measurement results at multiple time instances for the cell(s) in the measurement report (if available). For a (one or more) cell other than the cell(s), the UE may include the latest measurement result (e.g. at a single time instance) for the cell (or not include measurement result for the cell) in the measurement report.
The measurement result(s) may be (or comprise) cellResults, resultsSSB-Cell, resultsCSI-RS-Cell, MeasQuantityResults, RSRP, RSRQ, and/or SINR.
For example, measurement results at multiple time instances for a cell may be included in a measurement report. The measurement report may be triggered by a timer (e.g., periodically) and/or a measurement event. The multiple time instances are within a time window. The time window may be based on a reference time. The UE may perform measurement, prediction, sampling, and/or include the measurement results in the report based on the time window (and/or multiple time instances).
The time window (and/or multiple time instances) may be implicitly indicated or explicitly configured. The UE may determine whether to include (or exclude) a measurement result for a time instance based on the time window (e.g., whether the time instance is within (or outside) the time window). The UE may (be configured to) not include measurement results far away from the reference time (e.g., measurement results a time before the reference time, measurement results not within the time window, measurement result for a time instance outside the time window). The UE may (be configured to) include measurement results close to the reference time (e.g., the latest measurement results before the reference time, the measurement results within the time window, measurement result for a time instance within the time window). The UE may determine the actual time stamps of the measurement results. The UE may report (or include) the time stamps of the corresponding measurement results. The UE may report (up to) a (configured) number of measurement results.
For example, the time window (and/or multiple time instances) may be (or include, comprise) at least one or more of: a duration (or period of time) (containing a number of measurement results) ending (or starting) at the reference time, one or more time gaps (or durations, periods of time), measurement results for the latest (or closest) K time gaps (or durations, periods of time) (e.g., the measurement result obtained within (or based on) the time gap (or duration, period of time)) before (or after) the reference time, every N time instance (e.g., ms) (up to a number K) (e.g., N may be determined by the UE and K may be configured by the NW) before (or after) the reference time, (at most) a number of measurement results at different time instances before (or after) the reference time, and/or (up to) the latest (available) K measurement results at different time instances. The alphabet notations (e.g., N, K) may be numbers.
For example, the reference time may be (or include, comprise) at least one or more of: the time the UE performs (the latest) measurement (for a cell, frequency, and/or beam), the time the UE performs (the latest) prediction (for a cell, frequency, and/or beam), the time the UE obtains (the latest) (available) measurement (e.g., predicted and/or actually measured) (for a cell, frequency, and/or beam), the time the UE derives (the latest) (available) measurement (e.g., predicted and/or actually measured) (for a cell, frequency, and/or beam), the time the UE performs sampling for (the latest) (available) measurement (e.g., predicted and/or actually measured) (for a cell, frequency, and/or beam), the time of the latest (available) measurement result (e.g., predicted and/or actually measured) (for a cell, frequency and/or beam), the time of the latest (available) measurement result (e.g., predicted and/or actually measured) (for a cell, frequency, and/or beam) before the reference time, the time the UE triggers a report (e.g., based on a timer, event, and/or prediction) (for a cell, frequency, and/or beam), the time the UE sets a measurement result (e.g., predicted and/or actually measured) (for a cell, frequency, and/or beam), and/or the time the UE transmits a measurement report (for a cell, frequency, and/or beam).
For example, one or more parameters (e.g., parameters for the time window, the number of time instances, the number of measurement results) may be (or include, comprise) pre-configured by the NW (e.g., through broadcasting of Master Information Block (MIB), System Information Blocks (SIBs), specified in the specification), configured by the NW (e.g., through RRC message such as RRCReconfiguration, Medium Access Control (MAC) Control Element (CE), Downlink Control Information (DCI)) and/or determined by the UE (e.g., requested and/or indicated by the UE through UE-Assistance Information (UAI), RRCReconfigurationComplete, RRCResumeComplete, RRCSetupComplete, RRCReestablishmentComplete).
For example, the measurement results at multiple time instances (included in the report) may be equally spaced.
For example, the measurement results at multiple time instances (included in the report) may be predicted and/or actually measured.
For example, the time window (and/or multiple time instances) may be (or include, comprise) based on (or follow) configured timing (or multiple time instances) for measurement, prediction, sampling and/or resource (e.g., SSB, CSI-RS) transmission occasion (e.g., based on periodicity, offset, duration, frequency, and/or repetition). The UE may perform measurement, prediction, sampling, and/or include the measurement results in the report based on (or following) the configured timing (or multiple time instances) for sampling and/or resource (e.g., SSB, CSI-RS) transmission occasion (e.g., based on periodicity, offset, duration, frequency, and/or repetition).
The configuration (or indication) may indicate that the measurement results for which (or what) beam(s) should be provided (or included). The beam(s) may be (or comprises) for a serving cell, a neighbor cell, a Primary Cell (PCell), a Secondary Cell (SCell), a neighbor cell on a serving Measurement Object (MO), a configured cell, an indicated cell, an associated cell, an applicable cell, and/or a detected cell. When the UE (is configured to) include measurement results at multiple time instances in a measurement report, the UE may include measurement results at multiple time instances for the beam(s) in the measurement report (if available). For a (one or more) beam other than the beam(s), the UE may include the latest measurement result(s) (e.g. at a single time instance) for the beam in the measurement report.
The measurement result(s) may be (or comprise) rsIndexResults, resultsSSB-Indexes, resultsCSI-RS-Indexes, ResultsPerSSB-IndexList, ResultsPerSSB-Index, ResultsPerCSI-RS-IndexLists, ResultsPerCSI-RS-Index, MeasQuantityResults, RSRP, RSRQ, and/or SINR.
For example, measurement results at multiple time instances for a beam may be included in a measurement report. The measurement report may be triggered by a timer (e.g., periodically) and/or a measurement event. The multiple time instances are within a time window. The time window may be based on a reference time. The UE may perform measurement, prediction, sampling, and/or include the measurement results in the report based on the time window (and/or multiple time instances).
For example, the measurement report may be the first (type of) measurement report.
For example, the measurement report may be the second (type of) measurement report.
For example, the measurement report may not be the first (type of) measurement report.
For example, the measurement report may not be the second (type of) measurement report.

One or more method(s) (or examples) described below may be used for differentiation between measurement report(s) sent (or triggered) based on measurement event prediction or actual measurements, and/or one or more method(s) (or examples) described below may be used for differentiation between the first (type of) measurement report and the second (type of) measurement report:
The differentiation may be based on the message (or message type, or information element) used for the measurement report (e.g., different message types (or information elements) are used for the first (type of) measurement report and the second (type of) measurement report).
For example, a first message (or message type, or information element) may be used (by the UE) for the measurement report based on measurement event prediction (or the second (type of) measurement report). The first message (or message type, or information element) may not be used (by the UE) for the measurement report based on actual measurements (or the first (type of) measurement report).
For example, a second message (or message type, or information element) may be used (by the UE) for the measurement report based on actual measurements (or the first (type of) measurement report). The first message (or message type, or information element) may not be used (by the UE) for the measurement report based on measurement event prediction (or the second (type of) measurement report).
The first message (or message type, or information element) is different from the second message. The first message (or information element) and/or the second message (or message type, or information element) may be an RRC message (or information element). The second message (or message type, or information element) may be a measurement report (or measurement result information element).
The differentiation may be based on a field (or indication) in the measurement report.
For example, a field (or indication) may be included in the measurement report to indicate that the report is sent (or triggered) based on measurement event prediction (or the second (type of) measurement report).
For example, a field (or indication) may be included in the measurement report to indicate that the report is sent (or triggered) based on actual measurements (or the first (type of) measurement report).
The field(s) or indication(s) may be true/false value(s).
The field(s) or indication(s) may be (choice) of index (indices) or bitstring(s).

The NW may configure which concept(s) (or method(s)) or combination of concepts (or method(s)) to use. The UE may receive a message (e.g., RRCReconfiguration) and/or configuration (e.g., measurement configuration, report configuration) indicating which concept(s) (or method(s)) or combination of concepts (or method(s)) to use.

The UE may decide which concept(s) (or method(s)) or combination of concepts (or method(s)) to use.
For example, when (or in response to) an AI/ML functionality (e.g., RRM measurement prediction, measurement event prediction, RLF/HoF prediction) is (or being) capable/available/applicable/configured/activated/inferenced and/or the output of the AI/ML functionality is (or being) used, the UE may use Concept A, Concept B, Concept C, Concept D, and/or one or more specified examples or combinations including Concept A, Concept B, Concept C, Concept D, and/or one or more specified examples.
For example, when (or in response to) an AI/ML functionality (e.g., RRM measurement prediction, measurement event prediction, RLF/HoF prediction) is (or being) not capable/available/applicable/configured/activated/inferenced and/or the output of the AI/ML functionality is (or being) not used, the UE may use Concept A, Concept B, Concept C, Concept D, and/or one or more specified examples or combinations including Concept A, Concept B, Concept C, Concept D, and/or one or more specified examples.
For example, when (or in response to) the measurement result for a cell is (or being) above or below a threshold (e.g., configured by the NW, included in a message (e.g., RRCReconfiguration) or configuration (e.g., measurement configuration, report configuration)), the UE may use Concept A, Concept B, Concept C, Concept D, and/or one or more specified examples or combinations including Concept A, Concept B, Concept C, Concept D, and/or one or more specified examples. The cell may be a serving cell, a best neighbor cell of a frequency, a neighboring cell, and/or an average of multiple cells (or a function which takes multiple cells or measurement results as input).

The NW may configure which cell(s) to use the concept(s) (or method(s)) or combination of concepts (or method(s)). The UE may receive a message (e.g., RRCReconfiguration) and/or configuration (e.g., measurement configuration, report configuration) indicating which cell(s) to use the concept(s) (or method(s)) or combination of concepts (or method(s)).

The UE may decide which cell(s) to use the concept(s) (or method(s)) or combination of concepts (or method(s)).
For example, when (or in response to) an AI/ML functionality (e.g., RRM measurement prediction, measurement event prediction, RLF/HoF prediction) is (or being) capable/available/applicable/configured/activated/inferenced for a first cell and/or the output of the AI/ML functionality is (or being) used for a first cell, the UE may use Concept A, Concept B, Concept C, Concept D, and/or one or more specified examples or combinations including Concept A, Concept B, Concept C, Concept D, and/or one or more specified examples for a second cell.
For example, when (or in response to) an AI/ML functionality (e.g., RRM measurement prediction, measurement event prediction, RLF/HoF prediction) is (or being) not capable/available/applicable/configured/activated/inferenced for a first cell and/or the output of the AI/ML functionality is (or being) not used for a first cell, the UE may use Concept A, Concept B, Concept C, Concept D, and/or one or more specified examples or combinations including Concept A, Concept B, Concept C, Concept D, and/or one or more specified examples for a second cell.
For example, when (or in response to) the measurement result for a first cell is (or being) above or below a threshold (e.g., configured by the NW, included in a message (e.g., RRCReconfiguration) or configuration (e.g., measurement configuration, report configuration)), the UE may use Concept A, Concept B, Concept C, Concept D, and/or one or more specified examples or combinations including Concept A, Concept B, Concept C, Concept D, and/or one or more specified examples for a second cell. The first cell may be a serving cell, a best neighbor cell of a frequency, a neighboring cell, and/or an average of multiple cells (or a function which takes multiple cells or measurement results as input).
The first cell may be the same as the second cell. The first cell may be different from the second cell.

Various examples and embodiments of the present invention are described below. For the methods, alternatives, concepts, examples, and embodiments detailed above and herein, the following aspects and embodiments are possible.

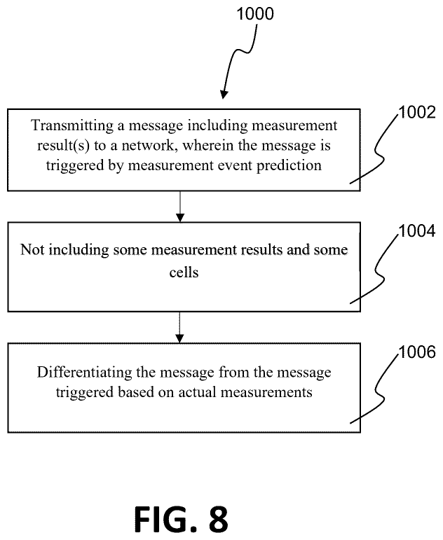

Referring to FIG. 8, with this and other concepts, systems, and methods of the present invention, a method 1000 for a UE in a wireless communication system comprises transmitting a message including measurement result(s) to a network, wherein the message is triggered by measurement event prediction (step 1002), not including some measurement results and some cells (step 1004), and differentiating the message from the message triggered based on actual measurements (step 1006).

In various embodiments, the UE provides an indication indicating whether the transmission of a message is triggered by actual measurements.

In various embodiments, the indication is associated to the measurement result.

In various embodiments, the indication is associated to the measurement report and the trigger of the event.

Referring back to FIGS. 3 and 4, in one or more embodiments from the perspective of a device (e.g., a UE) in a wireless communication system, the device 300 includes a program code 312 stored in memory 310 of the transmitter. The CPU 308 could execute program code 312 to: (i) transmit a message including measurement result(s) to a network, wherein the message is triggered by measurement event prediction; (ii) not include some measurement results and some cells; and (iii) differentiate the message from the message triggered based on actual measurements. Moreover, the CPU 308 can execute the program code 312 to perform all of the described actions, steps, and methods described above, below, or otherwise herein.

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) receive a message including measurement result(s) from a device (e.g., a UE), wherein the message is triggered by measurement event prediction; (ii) not include, at the device, some measurement results and some cells; and (iii) differentiate, at the device, the message from the message triggered based on actual measurements. Moreover, the CPU 308 can execute the program code 312 to perform all of the described actions, steps, and methods described above, below, or otherwise herein.

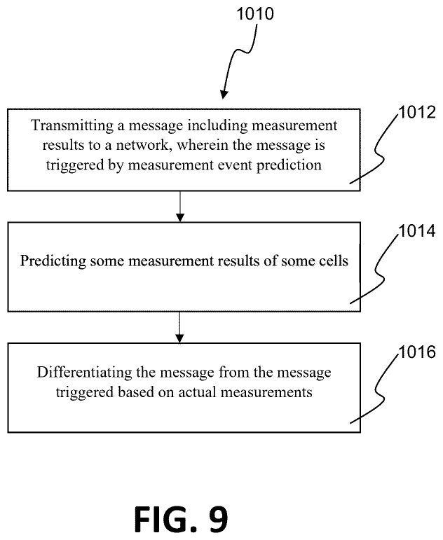

Referring to FIG. 9, with this and other concepts, systems, and methods of the present invention, a method 1010 for a UE in a wireless communication system comprises transmitting a message including measurement results to a network, wherein the message is triggered by measurement event prediction (step 1012), predicting some measurement results of some cells (step 1014), and differentiating the message from the message triggered based on actual measurements (step 1016).

In various embodiments, the UE provides an indication indicating whether the transmission of a message is triggered by actual measurements.

In various embodiments, the indication is associated to the measurement report and the trigger of the event.

Referring back to FIGS. 3 and 4, in one or more embodiments from the perspective of a device (e.g., a UE) in a wireless communication system, the device 300 includes a program code 312 stored in memory 310 of the transmitter. The CPU 308 could execute program code 312 to: (i) transmit a message including measurement results to a network, wherein the message is triggered by measurement event prediction; (ii) predict some measurement results of some cells; and (iii) differentiate the message from the message triggered based on actual measurements. Moreover, the CPU 308 can execute the program code 312 to perform all of the described actions, steps, and methods described above, below, or otherwise herein.

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) receive a message including measurement results from a device (e.g., a UE), wherein the message is triggered by measurement event prediction; (ii) predicting, at the device, some measurement results of some cells, and differentiate, at the device, the message from the message triggered based on actual measurements. Moreover, the CPU 308 can execute the program code 312 to perform all of the described actions, steps, and methods described above, below, or otherwise herein.

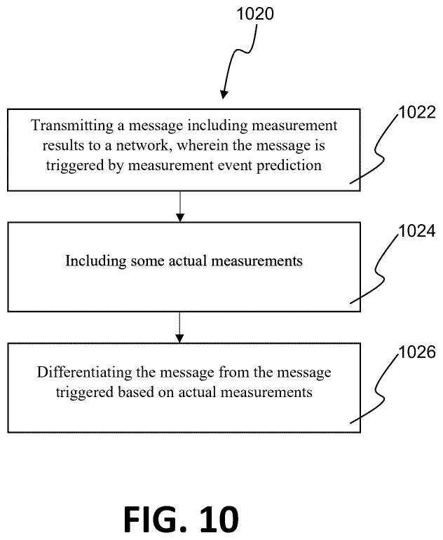

Referring to FIG. 10, with this and other concepts, systems, and methods of the present invention, a method 1020 for a UE in a wireless communication system comprises transmitting a message including measurement results to a network, wherein the message is triggered by measurement event prediction (step 1022), including some actual measurements (step 1024), and differentiating the message from the message triggered based on actual measurements (step 1026).

In various embodiments, the UE provides an indication indicating whether the transmission of a message is triggered by actual measurements.

In various embodiments, the indication is associated to the measurement report and the trigger of the event.

Referring back to FIGS. 3 and 4, in one or more embodiments from the perspective of a device (e.g., a UE) in a wireless communication system, the device 300 includes a program code 312 stored in memory 310 of the transmitter. The CPU 308 could execute program code 312 to: (i) transmit a message including measurement results to a network, wherein the message is triggered by measurement event prediction; (ii) include some actual measurements; and (iii) differentiate the message from the message triggered based on actual measurements. Moreover, the CPU 308 can execute the program code 312 to perform all of the described actions, steps, and methods described above, below, or otherwise herein.

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) receive a message including measurement results from a device (e.g., a UE), wherein the message is triggered by measurement event prediction; (ii) include some actual measurements; and (iii) differentiate, at the device, the message from the message triggered based on actual measurements. Moreover, the CPU 308 can execute the program code 312 to perform all of the described actions, steps, and methods described above, below, or otherwise herein.

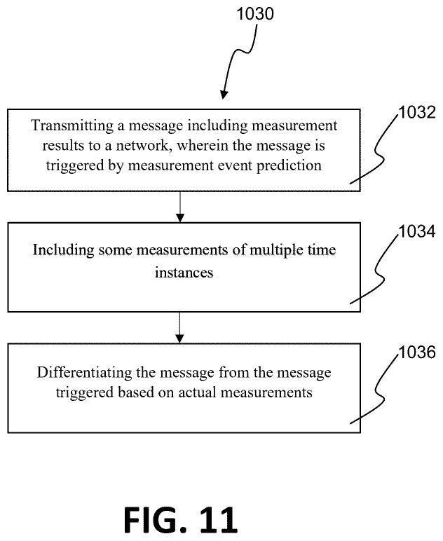

Referring to FIG. 11, with this and other concepts, systems, and methods of the present invention, a method 1030 for a UE in a wireless communication system comprises transmitting a message including measurement results to a network, wherein the message is triggered by measurement event prediction (step 1032), including some measurements of multiple time instances (step 1034), and differentiating the message from the message triggered based on actual measurements (step 1036).

In various embodiments, the UE provides an indication indicating whether the transmission of a message is triggered by actual measurements.

In various embodiments, the indication is associated to the measurement report and the trigger of the event.

Referring back to FIGS. 3 and 4, in one or more embodiments from the perspective of a device (e.g., a UE) in a wireless communication system, the device 300 includes a program code 312 stored in memory 310 of the transmitter. The CPU 308 could execute program code 312 to: (i) transmit a message including measurement results to a network, wherein the message is triggered by measurement event prediction; (ii) include some measurements of multiple time instances; and (iii) differentiate the message from the message triggered based on actual measurements. Moreover, the CPU 308 can execute the program code 312 to perform all of the described actions, steps, and methods described above, below, or otherwise herein.

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) receive a message including measurement results from a device (e.g., a UE), wherein the message is triggered by measurement event prediction; (ii) include some measurements of multiple time instances; and (iii) differentiate the message from the message triggered based on actual measurements. Moreover, the CPU 308 can execute the program code 312 to perform all of the described actions, steps, and methods described above, below, or otherwise herein.

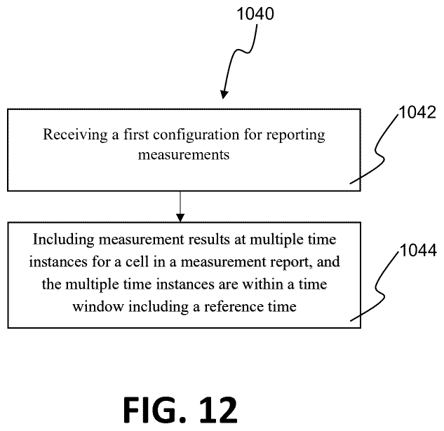

Referring to FIG. 12, with this and other concepts, systems, and methods of the present invention, a method 1040 for a UE in a wireless communication system comprises receiving a first configuration for reporting measurements (step 1042), and including measurement results at multiple time instances for a cell in a measurement report, and the multiple time instances are within a time window including a reference time (step 1044).

In various embodiments, the multiple time instances within the time window further includes time instances before and/or after the reference time.

In various embodiments, the reference time includes the time a report is triggered, the time a report is performed, the time reporting is performed, the time measurement results are set, the time the latest (available) measurement result is measured (or sampled, derived, predicted, collected, and/or obtained), the time a measurement event is predicted (or triggered), the time of a measurement report transmission, the time of an event entering (or leaving) condition fulfilled, and/or the time of the last transmitted (periodical or event triggered) measurement report.

In various embodiments, the time window is configured by an NW.

In various embodiments, the time window is included in an RRC reconfiguration message.

In various embodiments, the multiple measurement results include new measurements available since the last periodical or event triggered reporting or since the measurement was initiated or reset.

In various embodiments, the multiple measurement results include actually measured measurements and/or predicted measurements.

In various embodiments, the measurement report is event triggered and/or periodically triggered.

In various embodiments, the multiple measurement results at multiple time instances are included for all serving cells or a subset of serving cells.

In various embodiments, the multiple measurement results at multiple time instances are included for all neighboring cells or a subset of neighboring cells.

In various embodiments, the time window ends at (or starts from) the reference time.

In various embodiments, the time window includes one or more durations, one or more periods of time, a number (or list) of time instances (e.g., including specific frame and/or slots), and/or a number of measurement results.

In various embodiments, the measurement results include cell and/or beam measurements.

In various embodiments, the multiple measurement results (and/or time instances) are the closest before (or after) the reference time.

In various embodiments, the UE is indicated to report specific resource indices and/or measurement results of specific beams.

Referring back to FIGS. 3 and 4, in one or more embodiments from the perspective of a device (e.g., a UE) in a wireless communication system, the device 300 includes a program code 312 stored in memory 310 of the transmitter. The CPU 308 could execute program code 312 to: (i) receive a first configuration for reporting measurements; and (ii) include measurement results at multiple time instances for a cell in a measurement report, and the multiple time instances are within a time window including a reference time. Moreover, the CPU 308 can execute the program code 312 to perform all of the described actions, steps, and methods described above, below, or otherwise herein.

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) transmit a first configuration for reporting measurements; and (ii) include measurement results at multiple time instances for a cell in a measurement report, and the multiple time instances are within a time window including a reference time. Moreover, the CPU 308 can execute the program code 312 to perform all of the described actions, steps, and methods described above, below, or otherwise herein.

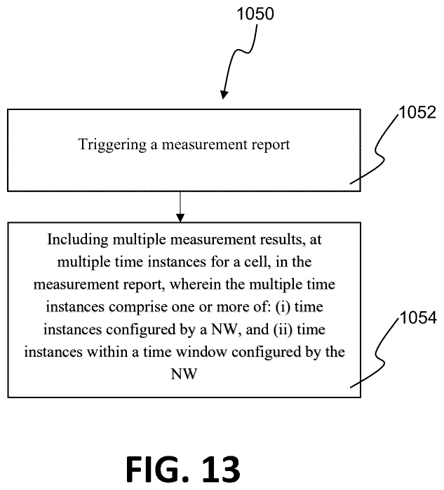

Referring to FIG. 13, with this and other concepts, systems, and methods of the present invention, a method 1050 for a UE in a wireless communication system comprises triggering a measurement report (step 1052), and including multiple measurement results, at multiple time instances for a cell, in a measurement report, wherein the multiple time instances comprise one or more of: (i) time instances configured by a NW, and (ii) time instances within a time window configured by the NW (step 1054).

In various embodiments, the multiple time instances comprises one or more time instances before, at, or after one or more of: (i) a time a measurement event is predicted; (ii) a time a measurement event is triggered; (iii) a time a measurement report is transmitted; (iv) a time an event entering condition is fulfilled; (v) a time an event leaving condition is fulfilled; (vi) a time of a last transmitted measurement report; (vii) a time of a last transmitted periodical measurement report; (viii) a time of a last transmitted event triggered measurement report; (ix) a time the UE performs measurement; (x) a time the UE performs the latest measurement; (xi) a time the UE performs a measurement prediction; (xii) a time the UE performs the latest measurement prediction; (xiii) a time the UE obtains a measurement; (xiv) a time the UE obtains the latest measurement; (xv) a time the UE triggers a measurement report; and (xvi) a time the UE sets a measurement result within a measurement report.

In various embodiments, the time instances configured by the NW further comprises one or more of: (i) the NW configuring the UE to report K measurement results, with K being a number configured by the NW; (ii) the NW configuring the UE to report at most K measurement results, with K being a number configured by the NW; (iii) the NW configuring the UE to report the latest K measurement results obtained by the UE, with K being a number configured by the NW; and (iv) the NW configuring the interval of the measurement results.

In various embodiments, the time instances within a time window configured by the NW further comprises the NW configuring a duration ending or starting at one or more of: (i) a time a measurement event is predicted; (ii) a time a measurement event is triggered; (iii) a time of a measurement report is transmitted; (iv) a time an event entering condition is fulfilled; (v) a time an event leaving condition is fulfilled; (vi) a time of a last transmitted measurement report; (vii) a time of a last transmitted periodical measurement report; (viii) a time of a last transmitted event triggered measurement report; (ix) a time the UE performs measurement; (x) a time the UE performs the latest measurement; (xi) a time the UE performs a measurement prediction; (xii) a time the UE performs the latest measurement prediction; (xiii) a time the UE obtains a measurement; (xiv) a time the UE obtains the latest measurement; (xv) a time the UE triggers a measurement report; and (xvi) a time the UE sets a measurement result within a measurement report.

In various embodiments, the UE includes the latest available measurement result actually measured at one or more of: (i) a time a measurement event is predicted; (ii) a time a measurement event is triggered; (iii) a time an event entering condition is fulfilled; (iv) a time an event leaving condition is fulfilled; and (v) a time a measurement report is transmitted, in the measurement report, when the measurement report is sent or triggered based on measurement event prediction.

In various embodiments, the UE includes new measurement(s) available since a last a last periodical reporting or an event triggered reporting, or since a measurement was initiated or reset, in the measurement report.

In various embodiments, the multiple measurement results comprise actually measured measurement(s), predicted measurement(s), or both actually measured measurement(s) and predicted measurement(s).

In various embodiments, the measurement report is triggered by predicted measurement event, predicted measurement(s) fulfilling a measurement event, actual measurement(s) fulfilling a measurement event, expiry of a timer, or if a measurement result is available.

In various embodiments, the multiple measurement results are included for one or more of: (i) all serving cells; (ii) a subset of serving cells; (iii) all neighboring cells; and (iv) a subset of neighboring cells.

In various embodiments, the UE performs RRM measurement prediction and/or obtains one or more measurement results for one or more of: (i) the cells included in the measurement report; (ii) the cells concerned with the predicted or triggered measurement event; and (iii) the cells indicated by the NW, when one or more of the following conditions occur: (i) an event entering condition or leaving condition is fulfilled; (ii) an event entering condition or leaving condition is predicted to be fulfilled; (iii) the UE sets or includes a measurement result; (iv) there is no measurement result available for a time instance; (v) the UE triggers a report; and (vi) the UE predicts a measurement event to happen.

Referring back to FIGS. 3 and 4, in one or more embodiments from the perspective of a device (e.g., a UE) in a wireless communication system, the device 300 includes a program code 312 stored in memory 310 of the transmitter. The CPU 308 could execute program code 312 to: (i) trigger a measurement report; and (ii) include multiple measurement results, at multiple time instances for a cell, in a measurement report, wherein the multiple time instances comprise one or more of: (i) time instances configured by a NW; and (ii) time instances within a time window configured by the NW. Moreover, the CPU 308 can execute the program code 312 to perform all of the described actions, steps, and methods described above, below, or otherwise herein.

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) trigger a measurement report, at a UE; and (ii) include multiple measurement results, at multiple time instances for a cell, in a measurement report, wherein the multiple time instances comprise one or more of: (i) time instances configured by a NW; and (ii) time instances within a time window configured by the NW. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
triggering a measurement report; and
including multiple measurement results, at multiple time instances for a cell, in the measurement report, wherein the multiple time instances comprise one or more of: (i) time instances configured by a Network (NW), and (ii) time instances within a time window configured by the NW.

2. The method of claim 1, wherein the multiple time instances comprise one or more time instances before, at, or after one or more of: (i) a time a measurement event is predicted; (ii) a time a measurement event is triggered; (iii) a time a measurement report is transmitted; (iv) a time an event entering condition is fulfilled; (v) a time an event leaving condition is fulfilled; (vi) a time of a last transmitted measurement report; (vii) a time of a last transmitted periodical measurement report; (viii) a time of a last transmitted event triggered measurement report; (ix) a time the UE performs a measurement; (x) a time the UE performs a latest measurement; (xi) a time the UE performs a measurement prediction; (xii) a time the UE performs a latest measurement prediction; (xiii) a time the UE obtains a measurement; (xiv) a time the UE obtains a latest measurement; (xv) a time the UE triggers a measurement report; and (xvi) a time the UE sets a measurement result within a measurement report.

3. The method of claim 1, wherein the time instances configured by the NW further comprise one or more of: (i) the NW configuring the UE to report K measurement results, with K being a number configured by the NW; (ii) the NW configuring the UE to report at most K measurement results, with K being a number configured by the NW; (iii) the NW configuring the UE to report a latest K measurement results obtained by the UE, with K being a number configured by the NW; and (iv) the NW configuring an interval of measurement results.

4. The method of claim 1, wherein the time instances within a time window configured by the NW further comprises the NW configuring a duration ending or starting at one or more of: (i) a time a measurement event is predicted; (ii) a time a measurement event is triggered; (iii) a time a measurement report is transmitted; (iv) a time an event entering condition is fulfilled; (v) a time an event leaving condition is fulfilled; (vi) a time of a last transmitted measurement report; (vii) a time of a last transmitted periodical measurement report; (viii) a time of a last transmitted event triggered measurement report; (ix) a time the UE performs measurement; (x) a time the UE performs a latest measurement; (xi) a time the UE performs a measurement prediction; (xii) a time the UE performs a latest measurement prediction; (xiii) a time the UE obtains a measurement; (xiv) a time the UE obtains a latest measurement; (xv) a time the UE triggers a measurement report; and (xvi) a time the UE sets a measurement result within a measurement report.

5. The method of claim 1, wherein the UE includes a latest available measurement result actually measured at one or more of: (i) a time a measurement event is predicted; (ii) a time a measurement event is triggered; (iii) a time an event entering condition is fulfilled; (iv) a time an event leaving condition is fulfilled; and (v) a time a measurement report is transmitted, in the measurement report, when the measurement report is sent or triggered based on measurement event prediction.

6. The method of claim 1, wherein the UE comprises one or more new measurements available since a last periodical reporting or an event triggered reporting, or since a measurement was initiated or reset, in the measurement report.

7. The method of claim 1, wherein the multiple measurement results comprise one or more actually measured measurements, one or more predicted measurements, or both one or more actually measured measurements and one or more predicted measurements.

8. The method of claim 1, wherein the measurement report is triggered by a predicted measurement event, one or more predicted measurements fulfilling a measurement event, one or more actual measurements fulfilling a measurement event, expiry of a timer, or if a measurement result is available.

9. The method of claim 1, wherein the multiple measurement results are included for one or more of: (i) all serving cells; (ii) a subset of serving cells; (iii) all neighboring cells; and (iv) a subset of neighboring cells.

10. The method of claim 1, wherein the UE performs Radio Resource Management (RRM) measurement prediction and/or obtains one or more measurement results for one or more of: (i) cells included in the measurement report; (ii) cells concerned with a predicted or triggered measurement event; and (iii) cells indicated by the NW, when one or more of the following conditions occur: (i) an event entering condition or leaving condition is fulfilled; (ii) an event entering condition or leaving condition is predicted to be fulfilled; (iii) the UE sets or includes a measurement result; (iv) there is no measurement result available for a time instance; (v) the UE triggers a report; and (vi) the UE predicts a measurement event to happen.

11. A User Equipment (UE), comprising:
a memory; and
a processor operatively coupled with the memory, wherein the processor is configured to execute a program code to:
trigger a measurement report; and
include multiple measurement results, at multiple time instances for a cell, in the measurement report, wherein the multiple time instances comprise one or more of: (i) time instances configured by a Network (NW), and (ii) time instances within a time window configured by the NW.

12. The UE of claim 11, wherein the multiple time instances comprise one or more time instances before, at, or after one or more of: (i) a time a measurement event is predicted; (ii) a time a measurement event is triggered; (iii) a time a measurement report is transmitted; (iv) a time an event entering condition is fulfilled; (v) a time an event leaving condition is fulfilled; (vi) a time of a last transmitted measurement report; (vii) a time of a last transmitted periodical measurement report; (viii) a time of a last transmitted event triggered measurement report; (ix) a time the UE performs measurement; (x) a time the UE performs a latest measurement; (xi) a time the UE performs a measurement prediction; (xii) a time the UE performs a latest measurement prediction; (xiii) a time the UE obtains a measurement; (xiv) a time the UE obtains a latest measurement; (xv) a time the UE triggers a measurement report; and (xvi) a time the UE sets a measurement result within a measurement report.

13. The UE of claim 11, wherein the time instances configured by the NW further comprise one or more of: (i) the NW configuring the UE to report K measurement results, with K being a number configured by the NW; (ii) the NW configuring the UE to report at most K measurement results, with K being a number configured by the NW; (iii) the NW configuring the UE to report latest K measurement results obtained by the UE, with K being a number configured by the NW; and (iv) the NW configuring an interval of the measurement results.

14. The UE of claim 11, wherein the time instances within a time window configured by the NW further comprise the NW configuring a duration ending or starting at one or more of: (i) a time a measurement event is predicted; (ii) a time a measurement event is triggered; (iii) a time a measurement report is transmitted; (iv) a time an event entering condition is fulfilled; (v) a time an event leaving condition is fulfilled; (vi) a time of a last transmitted measurement report; (vii) a time of a last transmitted periodical measurement report; (viii) a time of a last transmitted event triggered measurement report; (ix) a time the UE performs measurement; (x) a time the UE performs a latest measurement; (xi) a time the UE performs a measurement prediction; (xii) a time the UE performs a latest measurement prediction; (xiii) a time the UE obtains a measurement; (xiv) a time the UE obtains a latest measurement; (xv) a time the UE triggers a measurement report; and (xvi) a time the UE sets a measurement result within a measurement report.

15. The UE of claim 11, wherein the UE comprises a latest available measurement result actually measured at one or more of: (i) a time a measurement event is predicted; (ii) a time a measurement event is triggered; (iii) a time an event entering condition is fulfilled; (iv) a time an event leaving condition is fulfilled; and (v) a time a measurement report is transmitted, in the measurement report, when the measurement report is sent or triggered based on a measurement event prediction.

16. The UE of claim 11, wherein the UE comprises one or more new measurements available since a last periodical reporting or an event triggered reporting, or since a measurement was initiated or reset, in the measurement report.

17. The UE of claim 11, wherein the multiple measurement results comprise one or more actually measured measurements, one or more predicted measurements, or both one or more actually measured measurements and one or more predicted measurements.

18. The UE of claim 11, wherein the measurement report is triggered by a predicted measurement event, one or more predicted measurements fulfilling a measurement event, one or more actual measurements fulfilling a measurement event, expiry of a timer, or if a measurement result is available.

19. The UE of claim 11, wherein the multiple measurement results are included for one or more of: (i) all serving cells; (ii) a subset of serving cells; (iii) all neighboring cells; and (iv) a subset of neighboring cells.

20. The UE of claim 11, wherein the UE performs Radio Resource Management (RRM) measurement prediction and/or obtains one or more measurement results for one or more of: (i) cells included in the measurement report; (ii) cells concerned with the predicted or triggered measurement event; and (iii) cells indicated by the NW, when one or more of the following conditions occur: (i) an event entering condition or leaving condition is fulfilled; (ii) an event entering condition or leaving condition is predicted to be fulfilled; (iii) the UE sets or includes a measurement result; (iv) there is no measurement result available for a time instance; (v) the UE triggers a report; and (vi) the UE predicts a measurement event to happen.
